(19) United States
(12) Patent Application Publication
(10) Pub. No.: US 2026/0340463 A1
(43) Pub. Date: Oct. 29, 2026

(54) Artificially Intelligent Transpilation of General Quantum Circuits

(71) Applicant: International Business Machines Corporation, Armonk, NY (US)

(72) Inventors: Dhiraj MADAN, New Delhi (IN); Dhinakaran VINAYAGAMURTHY, Erode (IN); Anupama RAY, Bangalore (IN); Ritajit MAJUMDAR, Kolkata (IN); Mostafizur Rahaman LASKAR, Kolkata (IN); Kalyan Kanti DASGUPTA, Bengaluru (IN); L. Venkata SUBRAMANIAM, Sector 56 (IN); David KREMER GARCIA, White Plains, NY (US); Juan CRUZ BENITO, Salamanca (ES)

(21) Appl. No.: 19/187,361

(22) Filed: Apr. 23, 2025

(51) Int. Cl. G06N 10/20; G06N 3/092

(52) U.S. Cl. CPC G06N 10/20; G06N 3/092

(57) ABSTRACT

Systems/techniques that facilitate artificially intelligent transpilation of quantum circuits for quantum computing are provided. In various embodiments, a system can comprise a memory that can store computer executable components. In various embodiments, the system can further comprise a processor that can execute the computer executable components stored in the memory. In various aspects, the computer executable components can comprise an input component that can generate a circuit representation of a quantum circuit. In various embodiments, the computer executable components can further comprise a learning component that can generate, via a reinforcement learning model, a transpiled circuit of the quantum circuit based on the circuit representation.

### BACKGROUND

The subject disclosure relates to quantum circuit transpilation, and more specifically to artificially intelligent transpilation of general quantum circuits.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate artificially intelligent transpilation of general quantum circuits are described.

According to one or more embodiments, a system is provided. In various aspects, the system can comprise a memory that can store computer executable components. In various embodiments, the system can further comprise a processor that can execute the computer executable components stored in the memory. In various aspects, the computer executable components can comprise an input component that can generate a circuit representation of a quantum circuit. In various embodiments, the computer executable components can further comprise a learning component that can generate, via a reinforcement learning model, a transpiled circuit of the quantum circuit based on the circuit representation.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates artificially intelligent transpilation of general quantum circuits in accordance with one or more embodiments described herein.

FIG. 2 illustrates another block diagram of an example, non-limiting system that facilitates artificially intelligent transpilation of general quantum circuits in accordance with one or more embodiments described herein.

FIG. 3 illustrates another block diagram of an example, non-limiting system that facilitates artificially intelligent transpilation of general quantum circuits in accordance with one or more embodiments described herein.

FIG. 4 illustrates an example, non-limiting diagram showing how a reinforcement learning model determines a next gate for generating a transpiled quantum circuit in accordance with one or more embodiments described herein.

FIG. 5 illustrates an example, non-limiting diagram showing how a reinforcement learning model facilitates circuit transpilation in accordance with one or more embodiments described herein.

FIG. 6 illustrates another block diagram of an example, non-limiting system that facilitates artificially intelligent transpilation of general quantum circuits in accordance with one or more embodiments described herein.

FIG. 7 illustrates an example, non-limiting block diagram showing generation of circuit representations via a graph neural network in accordance with one or more embodiments described herein.

FIG. 8 illustrates an example, non-limiting block diagram of a training dataset in accordance with one or more embodiments described herein.

FIG. 9 illustrates an example, non-limiting block diagram showing how a graph neural network can be trained in accordance with one or more embodiments described herein.

FIG. 10 illustrates an example, non-limiting block diagram showing generation of circuit representations via a graph neural network in accordance with one or more embodiments described herein.

FIG. 11 illustrates an example, non-limiting block diagram of a training dataset in accordance with one or more embodiments described herein.

FIG. 12 illustrates an example, non-limiting block diagram showing how a classifier can be trained in accordance with one or more embodiments described herein.

FIG. 13 illustrates a flow diagram of an example, non-limiting computer-implemented method that facilitates artificially intelligent transpilation of general quantum circuits in accordance with one or more embodiments described herein.

FIG. 14 illustrates a flow diagram of an example, non-limiting computer-implemented method that facilitates artificially intelligent transpilation of general quantum circuits in accordance with one or more embodiments described herein.

FIG. 15 illustrates a flow diagram of an example, non-limiting computer-implemented method that facilitates artificially intelligent transpilation of general quantum circuits in accordance with one or more embodiments described herein.

FIG. 16 illustrates a flow diagram of an example, non-limiting computer-implemented method that facilitates artificially intelligent transpilation of general quantum circuits in accordance with one or more embodiments described herein.

FIG. 17 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

A quantum system is a device that uses qubits for information processing. A quantum circuit is a sequence of quantum gates that can be executed on a quantum system. Quantum systems are prone to noise, which disrupts qubit states and introduces errors. This is particularly problematic for circuits with large gate counts or deep gate depths, as longer execution times increase error rates. That is, gate counts in quantum circuits significantly affect both the running time and the fidelity of the quantum circuit. Thus, to obtain reliable results for quantum circuits with large gate counts or deep gate depth, such quantum circuits are transpiled into quantum circuits with smaller gate counts or gate depths. In quantum computing, transpilation is the process of transforming a quantum circuit into a circuit that can be efficiently executed on a quantum system. Specifically, transpilation can involve mapping logical qubits to physical qubits, adjusting gate sequences to comply with hardware constraints, and optimizing the circuit to reduce gate depth and minimize errors (e.g., synthesis of quantum circuits).

Existing techniques for transpilation of circuits utilize reinforcement learning. In particular, existing techniques that facilitate transpilation via reinforcement learning receive a quantum circuit as input. Then, a gate is sampled and added to a current circuit. In each iteration of reinforcement learning, the current circuit and the quantum circuit received as input is checked for equivalence. That is, after each iteration of adding a gate to the current circuit, the existing methods check if the current circuit is equivalent to the quantum circuit received as input. Such process of checking if the current circuit is equivalent to the quantum circuit in transpilation is referred to herein as equivalence checking.

However, the existing techniques which facilitate transpilation via reinforcement learning suffer from various disadvantages.

First, equivalence checking in existing techniques can be highly time-consuming. M any existing algorithms take exponential time to determine whether two quantum circuits are functionally identical (e.g., produce the same output given the same inputs). This can create a bottleneck during transpilation, as equivalence checking is often performed at each optimization step (e.g., after each gate is added to the current circuit). Although some existing allow for polynomial-time equivalence checking, they are limited to specific circuit families. In particular they are limited to Clifford, linear, and permutation circuits. As a result, transpilation of general quantum circuits is still computationally expensive, making large-scale applications challenging to implement efficiently on current hardware.

Second, existing techniques are not scalable to larger numbers of qubit, restricting their scalability for real-world quantum computing. In other words, existing techniques have scalability constraints in terms of the number of qubits they can process effectively. Such existing techniques face these scalability constraints due to the use of exponentially sized representations of quantum circuits. For example, some existing methods utilize full unitary matrices, which grow exponentially in size with the number of qubits. That is, the unitary matrices of such existing methods are of exponential dimensions, limiting the number of qubits to approximately 10 qubits. Additionally, some existing techniques assume a fixed initial state, limiting their applicability and effectiveness for general circuit transpilation, particularly when the quantum circuit is expected to function as a subroutine within a larger quantum computation.

Third, existing methods that utilize machine learning for transpilation face challenges in optimizing quantum circuits effectively for reduced gate depth or gate count. For instance, some existing techniques generate circuits based on high-level languages (e.g., C or C++). However, such existing techniques do not consistently lead to optimized quantum circuits, as they can abstract away crucial hardware constraints. Furthermore, such existing methods involve large training datasets, causing these existing methods to be data intensive and thus computationally demanding and resource intensive. Therefore, existing methods that employ machine learning exhibit a reduced overall effectiveness in practical quantum transpilation.

The various techniques described herein can help to address or ameliorate various of the above-described technical problems that plague existing techniques for facilitating circuit transpilation. In particular, the various techniques described herein can leverage graph neural networks in reinforcement learning so as to help solve such technical problems.

Specifically, when given a quantum circuit, various embodiments described herein can involve training a graph neural network so as to intelligently generate efficient circuit representations of quantum circuits such that equivalent circuits have a same circuit representation. Furthermore, various embodiments described herein can involve training a reinforcement learning model to generate a transpiled circuit of a quantum circuit based on the circuit representations. In various embodiments, the circuit representations can be embeddings of the quantum circuits.

In various aspects, the quantum circuit can be a general quantum circuit (e.g., any quantum circuit with no constraints or limitations on type of circuit). As non-limiting examples, the quantum circuit to be transpiled can be a Clifford circuit, a linear circuit, a permutation circuit, a quantum Fourier Transform circuit, a quantum error correction circuit, a variational quantum circuit, or otherwise any suitable circuit containing any suitable gates or any suitable quantum operations.

In various aspects, the various embodiments described herein can generate a circuit representation of the quantum circuit via a graph neural network. Furthermore, after each iteration of adding a gate to a current circuit during reinforcement learning, the various embodiments described herein can generate a circuit representation of the current circuit via the graph neural network. Thus, at each iteration, equivalence between the current circuit and the quantum circuit can be checked using the circuit representations generated by the graph neural network.

In various embodiments, the graph neural network can be trained to generate circuit representations of quantum circuits such that equivalent circuits have the same or close representations and inequivalent circuits have far apart representations. More specifically, in the graph neural network, the distance between circuit representations refers to the difference between their learned embeddings in the high-dimensional space. A smaller distance indicates that the graph neural network has identified the circuits as structurally or functionally similar, while a larger distance suggests they are distinct. This distance metric is used to guide the training process, ensuring that equivalent circuits are mapped closer together and non-equivalent circuits are pushed further apart in the embedding space. Accordingly, the various embodiments described herein can efficiently check equivalence between the quantum circuit and the current circuit during transpilation, and thus improving efficiency of transpilation of general quantum circuits.

In various cases, rewards can be generated for the reinforcement learning model based on checking equivalence between the quantum circuit and the current circuit. Accordingly, such rewards can be used to continuously train the reinforcement learning model.

In various instances, the various embodiments described herein can facilitate equivalence checking through contrastive learning. More specifically, positive and negative pairs of circuits can be generated to train the graph neural network. That is, pairs of equivalent circuits and pairs of non-equivalent circuits can be generated. Thereafter, the graph neural network can generate circuit representations of the pairs of equivalent circuits and the pairs of non-equivalent circuits, which can be used to train the graph neural network to check for equivalence through contrastive learning.

In other instances, the various embodiments described herein can facilitate equivalence checking through circuit classification. More specifically, the graph neural network can generate circuit representations of matrix products of a circuit and a transpose of an equivalent circuit. Similarly, the graph neural network can generate circuit representations of matrix products of a circuit and a transpose of a non-equivalent circuit. Thereafter, a classifier can be trained on the circuit representations of the matrix products to determine if a circuit representation of the matrix product represents an identity circuit or not. If the circuit representation of the matrix product represents the identity circuit, it indicates that the two circuits in the matrix product are equivalent. Accordingly, by training the classifier to determine if a circuit representation of the matrix product represents an identity circuit, the classifier can be trained to determine if two circuits are equivalent or not.

Thus, various embodiments described herein can consume significantly less time with less implementation costs and wider application to general quantum circuits than existing techniques for transpiling quantum circuits.

Various embodiments described herein can be considered as a computerized tool (e.g., any suitable combination of computer-executable hardware or computer-executable software) that can facilitate artificially intelligent transpilation of general quantum circuits for quantum computing. In various aspects, such a computerized tool can comprise an input component, a learning component, a training component, and/or a verification component.

In various embodiments, there can be a quantum system. In various aspects, the quantum system can comprise any suitable number of qubits. In various instances, such qubits can exhibit any suitable structures, constructions, or architectures (e.g., can be superconducting qubits, spin qubits, or quantum dots). In various cases, the qubits of the quantum system can be arranged or connected according to any suitable coupling topology.

In various embodiments, there can be a quantum circuit. In various aspects, the quantum circuit can be composed or otherwise made up of any suitable quantum gates (e.g., single-qubit gates, or two-qubit entangling gates). In any case, it can be desirable to implement, execute, or otherwise perform the quantum circuit on the quantum system efficiently. For example, the quantum circuit can be currently formatted such that it can not be implemented on the quantum system or it can not be implemented efficiently on the quantum system (e.g., the gate count or gate depth of the quantum circuit may be too large to implement efficiently on the quantum system).

In various aspects, it can be desired to transpile the quantum circuit so that it is efficiently implementable on the quantum system. That is, it can be desired to transpile the quantum circuit so that it can be implemented on the quantum system with a shorter gate depth or reduced gate count. As described herein, the computerized tool can facilitate such transpilation of the quantum circuit.

In various embodiments, the input component of the computerized tool can electronically access, via any suitable wired or wireless electronic connections, the quantum system. In various instances, the input component can further access or otherwise receive, retrieve, or import from any suitable source the quantum circuit. For example, the input component can obtain the quantum circuit from any suitable centralized or decentralized data structure (e.g., graph data structure, relational data structure, hybrid data structure), whether remote from or local to the input component. In any case, the input component can access the quantum system or the quantum circuit, such that other components of the computerized tool can electronically interact with (e.g., power-up, power-down, initialize, control) the quantum system or can electronically interact with (e.g., read, write, edit, copy, manipulate, execute) the quantum circuit.

In various embodiments, the learning component can electronically store, maintain, control, or otherwise access a reinforcement learning model.

In various aspects, the reinforcement learning model can exhibit any suitable internal architecture. In various instances, the reinforcement learning model can be a deep learning neural network. For example, the reinforcement learning model can include any suitable numbers of any suitable types of layers (e.g., input layer, one or more hidden layers, output layer, any of which can be convolutional layers, dense layers, long short-term memory (LSTM) layers, non-linearity layers, pooling layers, batch normalization layers, or padding layers). As another example, the reinforcement learning model can include any suitable numbers of neurons in various layers (e.g., different layers can have the same or different numbers of neurons as each other). As yet another example, the reinforcement learning model can include any suitable activation functions (e.g., softmax, sigmoid, hyperbolic tangent, rectified linear unit) in various neurons (e.g., different neurons can have the same or different activation functions as each other). As still another example, the reinforcement learning model can include any suitable interneuron connections or interlayer connections (e.g., forward connections, skip connections, recurrent connections).

Regardless of its specific internal architecture, the reinforcement learning model can be configured to transpile a quantum circuit. That is, the reinforcement learning model can be configured to receive as input any quantum circuit and to determine as output a sequence of gates that is equivalent to the quantum circuit. Accordingly, the learning component can electronically execute the reinforcement learning model on the quantum circuit, and such execution can yield a sequence of gates. More specifically, the learning component can feed the quantum circuit to the input layer of the reinforcement learning model, the quantum circuit can complete a forward pass through the one or more hidden layers of the reinforcement learning model, and the output layer of the reinforcement learning model can determine a sequence of gates based on activations provided by the one or more hidden layers of the reinforcement learning model.

In various embodiments, the training component of the computerized tool can train the reinforcement learning model to transpile the quantum circuit via reinforcement learning. Specifically, the training component can apply a reward based on whether the current circuit and the quantum circuit received as input are equivalent.

Additionally, the learning component can electronically store, maintain, control, or otherwise access a graph neural network.

In various aspects, the graph neural network can exhibit any suitable internal architecture. For example, the graph neural network can include any suitable numbers of any suitable types of layers (e.g., input layer, one or more hidden layers, output layer, any of which can be message-passing layers, aggregation layers, graph convolutional layers, graph attention layers, graph recurrent layers, dense layers, long short-term memory (LSTM) layers, non-linearity layers, pooling layers, batch normalization layers, or padding layers). As another example, the graph neural network can include any suitable numbers of node or edge features in various layers (e.g., different layers can support varying feature dimensions). As yet another example, the graph neural network can include any suitable activation functions (e.g., softmax, sigmoid, hyperbolic tangent, rectified linear unit) to process node or graph embeddings. As still another example, the graph neural network can include any suitable connectivity patterns (e.g., forward connections, residual connections, skip connections, recurrent connections, attention-based message passing).

Regardless of its specific internal architecture, the graph neural network can be configured to generate a circuit representation of a quantum circuit such that circuits that are equivalent are mapped to similar or identical representations. That is, the graph neural network can be configured to receive as input any quantum circuit and to determine as output a circuit representation of the quantum circuit. Accordingly, the learning component can electronically execute the graph neural network on the quantum circuit, and such execution can yield a circuit representation of the quantum circuit. More specifically, the learning component can feed the quantum circuit to the input layer of the graph neural network, the quantum circuit can complete a forward pass through the one or more hidden layers of the graph neural network, and the output layer of the graph neural network can determine a circuit representation based on activations provided by the one or more hidden layers of the graph neural network.

In various embodiments, the training component of the computerized tool can train the graph neural network to generate a circuit representation of a quantum circuit such that equivalent circuits have representations that are closer and non-equivalent circuits have representations that are farther apart.

In some cases, the learning component can electronically store, maintain, control, or otherwise access a classifier.

In various aspects, the classifier can exhibit any suitable internal architecture. For example, the classifier can include any suitable numbers of any suitable types of layers (e.g., input layer, one or more hidden layers, output layer, any of which can be convolutional layers, dense layers, long short-term memory (LSTM) layers, non-linearity layers, pooling layers, batch normalization layers, or padding layers). As another example, the classifier can include any suitable numbers of neurons in various layers (e.g., different layers can have the same or different numbers of neurons as each other). As yet another example, the classifier can include any suitable activation functions (e.g., softmax, sigmoid, hyperbolic tangent, rectified linear unit) in various neurons (e.g., different neurons can have the same or different activation functions as each other). As still another example, the classifier can include any suitable interneuron connections or interlayer connections (e.g., forward connections, skip connections, recurrent connections).

Regardless of its specific internal architecture, the classifier can be configured to transpile a quantum circuit. That is, the classifier can be configured to receive as input a circuit representation (e.g., a circuit representation generated by the graph neural network) of a matrix product of a first circuit and a transpose of a second circuit and to determine as output if the circuit representation represents the identity circuit. In other words, the classifier can be configured to receive as input a circuit representation of a matrix product of the first circuit and a transpose of the second circuits and to determine as output if the first and second circuit are equivalent. Accordingly, the learning component can electronically execute the classifier on the quantum circuit, and such execution can yield a sequence of gates. M ore specifically, the learning component can feed the quantum circuit to the input layer of the classifier, the quantum circuit can complete a forward pass through the one or more hidden layers of the classifier, and the output layer of the classifier can determine if the first and second circuit is equivalent based on activations provided by the one or more hidden layers of the classifier.

In various embodiments, the training component of the computerized tool can train the classifier to determine if two circuits are equivalent based on whether their matrix product is equivalent to the identity circuit.

In various embodiments, the learning component can leverage the reinforcement learning model, graph neural network and/or classifier as follows. In various cases, the learning component can execute that reinforcement learning model on a circuit representation of a quantum circuit generated by the graph neural network, and such execution can yield a next gate to add to a current circuit. In various cases, the verification component of the computerized tool can check equivalence, via the graph neural network, between the current circuit and the quantum circuit based on circuit representations. In other instances, the verification component can check equivalence between the current circuit and the quantum circuit based on circuit representations via the classifier. In various aspects, the learning component can repeat this procedure until a sequence of gates is found that is equivalent to the quantum circuit. In other words, the reinforcement learning model can determine the sequence of gates in an iterative synthesis process. Specifically, the learning component can iteratively execute the reinforcement learning model on the circuit representations of the quantum circuit to iteratively determine a next gate in the current circuit until the current circuit is equivalent to the quantum circuit.

In this way, the quantum circuit can be transpiled without excessive consumption of time and can result in shorter transpiled circuits than that of existing methods. Indeed, various embodiments described herein can be considered as transpiling (e.g., as synthesizing and optimizing) quantum circuits in an intelligent manner (as determined by the reinforcement learning model based on circuit representations generated by the graph neural network). Thus, the number of gates in the transpiled circuit can be reduced, and thus reduce implementation costs of the transpiled circuit.

In various embodiments, the execution component of the computerized tool can take any suitable electronic actions, based on the transpiled circuit. As a non-limiting example, the execution component can electronically command or instruct the quantum system to execute or perform the transpiled circuit. Accordingly, the execution component can electronically command or instruct the quantum system to execute or otherwise perform the transpiled circuit (e.g., can initialize the qubits of the quantum system in any suitable fashion, can cause those initialized qubits to perform whatever sequence of quantum operations is called for by the transpiled circuit, and can cause whatever resultant quantum states are taken on by the qubits of the quantum system to be read or measured).

Note that, in order for circuit transpilation to be accurately or correctly performed, the herein-described reinforcement learning model, graph neural network, and/or classifier should first undergo training. In various cases, the computerized tool can train such reinforcement learning model, graph neural network, and/or classifier using any suitable training paradigms (e.g., via supervised training, unsupervised training, reinforcement training).

Various embodiments described herein can be employed to use hardware or software to solve problems that are highly technical in nature (e.g., to facilitate artificially intelligent transpilation of quantum circuits for quantum computing), that are not abstract and that cannot be performed as a set of mental acts by a human. Further, some of the processes performed can be performed by a specialized computer (e.g., quantum systems comprising tangible qubits that can execute or implement quantum circuits; reinforcement learning models that are configured to transpile a quantum circuit, graph neural networks that are configured to generate efficient circuit representations of quantum circuits, classifiers that are configured to check equivalence between circuits).

Neither the human mind nor a human with pen and paper can: electronically receive a quantum circuit; electronically execute a graph neural network on the quantum circuit to generate a circuit representation of the quantum circuit; execute a reinforcement learning model on that circuit representation so as to determine a sequence of gates that is equivalent to the quantum circuit; electronically train the reinforcement learning model by applying rewards based on equivalence between the quantum circuit and a current circuit; generating pairs of equivalent circuits and pairs of non-equivalent circuits to electronically train the graph neural network on; electronically train the classifier based on the pairs of equivalent circuits and pairs of non-equivalent circuits to determine if two circuits are equivalent; and electronically cause the transpiled circuit to be executed or performed on the quantum system. After all, a quantum system is a specialized piece of computing hardware that utilizes physical qubits (e.g., superconducting qubits, such as transmons) to process information. Physical qubits cannot be implemented by the human mind or by a human with pen and paper. Moreover, a quantum circuit can be a sequence of quantum gates that can be executed on a quantum system. Neither the human mind, nor a human with pen and paper, can transpile or otherwise manipulate quantum gates or execute quantum gates on physical qubits. Additionally, artificial neural networks (e.g., graph neural networks, classifiers, deep learning neural networks) are also inherently computerized constructs comprising specific software-oriented architectures (e.g., input layers, hidden layers, or output layers, any of which can be made up of trainable or non-trainable internal parameters such as convolutional layers or LSTM layers). Artificial neural networks cannot be trained or executed by the human mind, or by humans with mere pen and paper, in any reasonable or practicable way without computers. Also, the very field of quantum circuit transpilation is focused on electronically translating or reformatting quantum circuits so that they can be implementable or executable efficiently on specific quantum hardware. It would make no sense whatsoever to discuss the field of quantum circuit transpilation outside of a computing context. Therefore, a computerized tool that can facilitate circuit transpilation via implementation of artificial neural networks is inherently computerized and cannot be implemented in any sensible, practicable, or reasonable way without computers.

It should be appreciated that the figures and the herein disclosure describe non-limiting examples of various embodiments. It should further be appreciated that the figures are not necessarily drawn to scale.

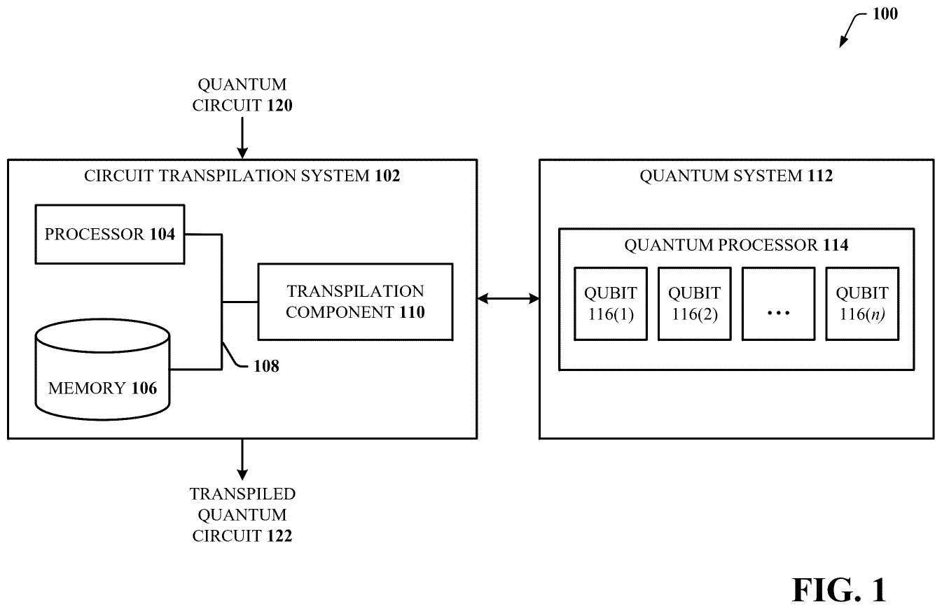

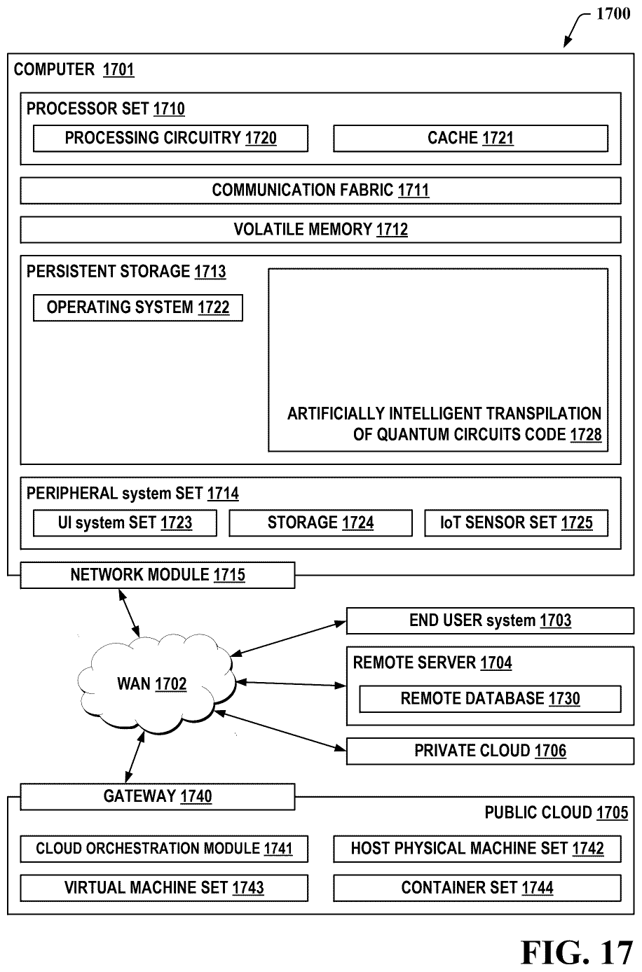

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1700 illustrated at FIG. 17. For example, non-limiting system 100 can be associated with, such as accessible via, a computing environment 1700 described below with reference to FIG. 17, such that aspects of processing can be distributed between non-limiting system 100 and the computing environment 1700. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can facilitate artificially intelligent transpilation of general quantum circuits in accordance with one or more embodiments described herein. As shown, a circuit transpilation system 102 can be electronically integrated, via any suitable wired or wireless electronic connections, with a quantum system 112.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., transpilation component 110, input component 202, learning component 204, training component 206, verification component 208, and/or execution component 210) to perform one or more actions. In one or more embodiments, memory 106 can store computer-executable components (e.g., transpilation component 110, input component 202, learning component 204, training component 206, verification component 208, and/or execution component 210).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

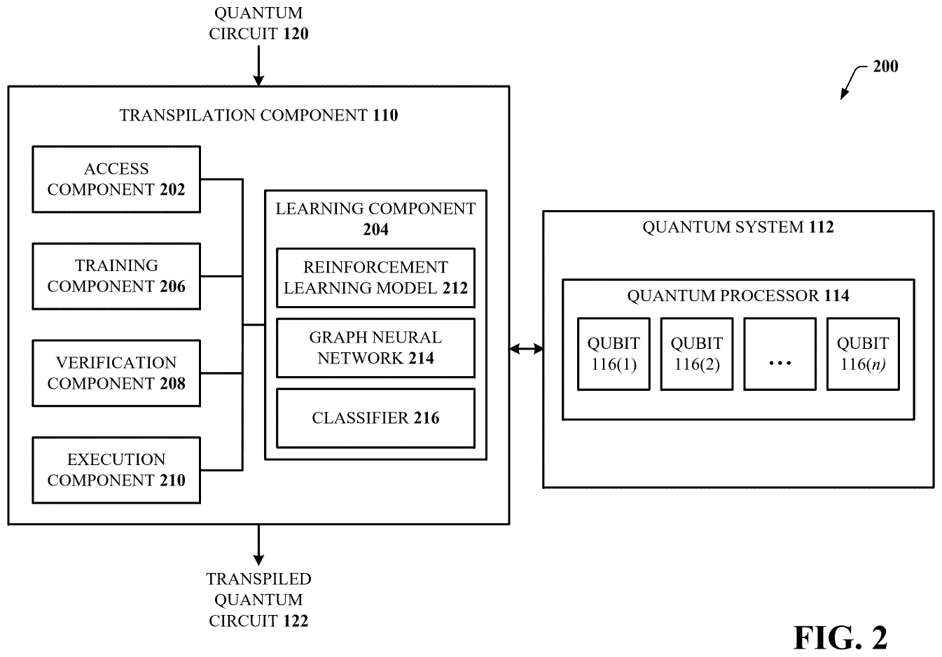

In various embodiments, transpilation component 110 can comprise input component 202, learning component 204, training component 206, verification component 208, and execution component 210, as illustrated in FIG. 2.

As illustrated in FIG. 1, non-limiting system 100 can comprise circuit transpilation system 102 and quantum system 112. That is, the non-limiting system 100 can facilitate circuit transpilation via reinforcement learning based on circuit representations, in combination with employment of the quantum system 112. Circuit transpilation system 102 can be coupled (operatively, communicatively, electrically, and/or like function) to quantum system 112.

In various embodiments, the quantum system 112 can be any suitable quantum computing device or quantum computing hardware. In various aspects, the quantum system 112 can comprise or otherwise include a quantum processor 114. The quantum processor 114 can comprise a set of qubits 116. In various instances, the set of qubits 116 can have n qubits for any suitable positive integer n: a qubit 116(1) to a qubit 116(n). In various cases, any of the set of qubits 116 can exhibit any suitable structure or architecture. As a non-limiting example, any of such qubits can exhibit a superconducting qubit architecture (e.g., such qubit can be constructed from any suitable number of Josephson junctions shunted by any suitable number of planar capacitor pads). As another non-limiting example, any of such qubits can exhibit a quantum dot architecture. As yet another non-limiting example, any of such qubits can exhibit a spin qubit architecture. In various aspects, different qubits of the set of qubits 116 can exhibit the same or different structures or architectures as each other. Although not explicitly shown in FIG. 1, the quantum system 112 can comprise or otherwise be associated with any suitable hardware or software (e.g., real-time controllers implemented in field programmable gate arrays of the quantum system 112) that can be used to initialize any of the set of qubits 116, or that can be used to perform any suitable quantum operations (e.g., quantum gates, qubit measurements, qubit idling) on the set of qubits 116.

In various embodiments, the quantum circuit 120 can be any suitable sequence of any suitable types of quantum gates (e.g., Pauli gates, Hadamard gates, Phase gates, entangling gates). As a non-limiting example, the quantum circuit 120 can be a Clifford circuit (e.g., a circuit composed of gates from the Clifford group, such as the Hadamard H, Phase S, and Controlled-NOT CX gates). As another non-limiting example, the quantum circuit 120 can be a linear circuit (e.g., a circuit composed of linear transformations). As still another non-limiting example, the quantum circuit 120 can be a permutation circuit (e.g., a quantum circuit consisting of SWAP gates and Controlled-SWAP (Fredkin) gates to rearrange qubit positions without altering their states). As yet another non-limiting example, the quantum circuit 120 can be a quantum Fourier transform (QFT) circuit (e.g., a circuit composed of Hadamard gates and controlled-phase gates, which perform the quantum analogue of the discrete Fourier transform). As even another non-limiting example, the quantum circuit 120 can be a quantum error correction circuit (e.g., a circuit composed of stabilizer operations to detect and correct quantum errors). As still another non-limiting example, the quantum circuit 120 can be a variational quantum circuit (e.g., a circuit composed of parameterized rotation gates (RX, RY, RZ) and entangling gates (CX, CZ) used for variational quantum algorithms). As yet another non-limiting example, the quantum circuit 120 can be a quantum arithmetic circuit (e.g., a circuit composed of Toffoli, Controlled-NOT, and modular addition gates to perform arithmetic operations in quantum algorithms).

In various instances, it can be desired to transpile the quantum circuit 120 to be implementable, executable, or performable on the quantum system 112.

In various cases, it can be physically or theoretically possible to execute or perform the quantum circuit 120 on the architecture of the quantum system 112, but such execution or performance can be exceedingly inconvenient or burdensome. In such situations, the quantum circuit 120 can be considered as not efficiently implementable on the quantum system 112. Thus, it can be desired to transpile the quantum circuit 120 to enable efficient implementation of the quantum circuit 120 on the quantum system 112. For instance, it can be desired to transpile quantum circuit 120 to reduce gate count or gate depth of the quantum circuit 120.

As a non-limiting example, suppose that the quantum circuit 120 implements a quantum Fourier transform (QFT) on a large number of qubits. While the quantum system 112 may support all the necessary quantum gates (e.g., Hadamard, controlled phase, and swap gates) required for QFT, the direct implementation of the circuit may result in an extremely high gate depth due to the large number of controlled phase operations. Since each additional qubit in the QFT circuit roughly doubles the number of gates required, executing the circuit as-is could introduce excessive noise and decoherence, leading to unreliable results. Thus, although the quantum circuit 120 can theoretically be executed on quantum system 112, the quantum circuit 120 in such a case can nevertheless be considered inefficiently implementable on the quantum system 112. Accordingly, transpilation of quantum circuit 120 can be desirable to optimize the circuit for reduced gate depth and improved fidelity.

As described herein, the circuit transpilation system 102 can facilitate such transpilation of quantum circuit 120. That is, circuit transpilation system 102 can receive quantum circuit 120 as input and produce transpiled quantum circuit 124 as output.

In various embodiments, the transpilation component 110 can receive the quantum circuit 120 as input. In various aspects, transpilation component 110 can transpile the quantum circuit 120 via a reinforcement learning model 212. More specifically, the transpilation component 110 can generate a circuit representation of the quantum circuit 120 via a graph neural network. Accordingly, transpilation component 110 can execute the reinforcement learning model 212 on the circuit representation of quantum circuit 120 to generate as output transpiled quantum circuit 122. That is, the transpiled quantum circuit 124 can be considered as the transpiled version of the quantum circuit 120.

FIG. 2 illustrates another block diagram of an example, non-limiting system 200 that facilitates artificially intelligent transpilation of general quantum circuits in accordance with one or more embodiments described herein.

In various instances, the input component 202 can electronically receive, retrieve, obtain, import, or otherwise access, from any suitable data structures or from any suitable computing devices, quantum circuit 120. In any case, the input component 202 can electronically access (e.g., send or receive data or program instructions to or from) the quantum system 112 or the quantum circuit 120, such that other components of the circuit transpilation system 102 can electronically interact with the quantum system 112 or the quantum circuit 120. That is, in various embodiments, the input component 202 can receive the quantum circuit 120 as input.

In various embodiments, the input component 202 can electronically access, in any suitable fashion, the quantum system 112, such that the circuit transpilation system 102 can electronically activate (e.g., power-up), electronically deactivate (e.g., power-down), or otherwise electronically control the quantum system 112.

In various aspects, learning component 204 can transpile quantum circuit 120 to be implementable via reinforcement learning model 212. More specifically, learning component 204 can transpile quantum circuit 120 into a sequence of gates that are implementable on quantum system 112. In various aspects, the sequence of gates can be considered the transpiled quantum circuit 124. That is, the transpiled quantum circuit 124 can be considered as a functionally equivalent (to within any suitable threshold fidelity) version of the quantum circuit 120 that is executable, implementable, or performable on the quantum system 112. In various embodiments, the learning component 204 can generate the transpiled quantum circuit 124 via reinforcement learning model 212 such that the transpiled quantum circuit 124 can be implemented efficiently on quantum system 112 (e.g., or otherwise more efficiently than quantum circuit 120).

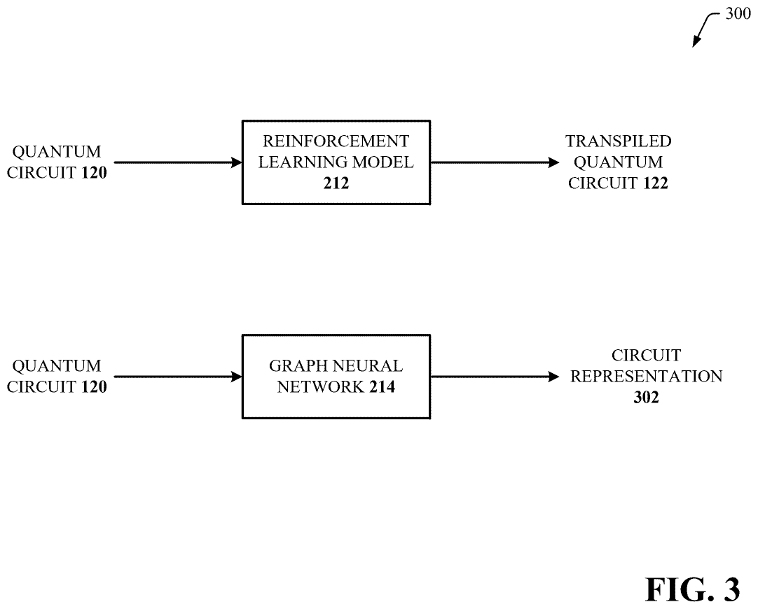

In various instances, as described herein, the learning component 204 can generate the transpiled quantum circuit 122 by leveraging the reinforcement learning model 212 and the graph neural network 214 Non-limiting aspects are described with respect to FIGS. 3-5.

In various embodiments, the learning component 204 can electronically store, maintain, control, or otherwise access the reinforcement learning model 212, graph neural network 214, and classifier 216.

In various embodiments, in response to the reinforcement learning model 212 receiving the quantum circuit 120 as input, the input component 202 can execute the graph neural network 214 on the quantum circuit 120, thereby producing a circuit representation of the quantum circuit 120. In various aspects, the graph neural network 214 can generate circuit representations of quantum circuits such that equivalent circuits have representations that are close to each other, and such that non-equivalent circuits have representations that are far from each other. That is, equivalent circuit representations in the latent space of the graph neural network 214 are mapped to nearby points, and non-equivalent circuit representations are mapped to points that are farther apart.

In various aspects, based on the circuit representation of quantum circuit 120, the reinforcement learning model 212 can compute a reward. More specifically, as the transpiled quantum circuit 122 is being updated (e.g., as a current circuit is being updated during reinforcement learning), verification component 208 can determine the reward based on the circuit representation of the quantum circuit 120 and a circuit representation of the transpiled quantum circuit 122 after an update. That is, the verification component 208 can check if the circuit representation of the quantum circuit 120 and the circuit representation of the transpiled quantum circuit 122 are equivalent. Thereafter, based on the equivalence between the circuit representation of the quantum circuit 120 and the circuit representation of the transpiled quantum circuit 122, verification component 208 can determine the reward to apply to the reinforcement learning model 212.

To check for equivalence, the verification component 208 can use contrastive learning to train the graph neural network 214. In various aspects, to facilitate such contrastive learning, the training component 206 can generate pairs of equivalent circuits (e.g., positive pairs) and pairs on non-equivalent circuits (e.g., negative pairs). In various instances, the training component 206 can generate pairs of equivalent circuits via any suitable transpilation method. In various aspects, the training component 206 can generate pairs of non-equivalent circuits via random sampling. Thereafter, the training component 206 can generate respective circuit representations of the pairs of equivalent circuits and the pairs of non-equivalent circuits. More specifically, for each circuit, the training component 206 can generate a circuit representation for the circuit, for its equivalent circuit, and for its non-equivalent circuit. Accordingly, the training component 206 can train the graph neural network 214 on the circuit representations of the pairs of equivalent circuits and the pairs of non-equivalent circuits such that equivalent circuits have representations that are close to each other, and such that non-equivalent circuits have representations that are far from each other. In various embodiments, the distance (or closeness) between circuit representations can be measured based on Euclidean distance between the circuit representations.

Alternatively, the verification component 208 can train classifier 216 to check equivalence between the quantum circuit 120 and the transpiled quantum circuit 122. In various aspects, the verification component 208 can generate a matrix product of the quantum circuit 120 and a transpose of the transpiled quantum circuit 122 (e.g., or a matrix product of the transpiled quantum circuit 122 and a transpose of the quantum circuit 120). Thereafter, the verification component 208 can generate, via graph neural network 214, a circuit representation of the matrix product. Accordingly, the verification component 208 can execute the classifier on the circuit representation of the matrix product, thereby yielding a classification identifying if the circuit representation represents or does not represent the identity circuit. If the circuit representation does represent the identity circuit, it indicates that quantum circuit 120 is equivalent to the transpiled quantum circuit 122 (e.g., the transpose of transpiled quantum circuit 122 effectively reverses all operations of the quantum circuit 120). Conversely, if the circuit representation does not represent the identity circuit, it indicates that quantum circuit 120 is not equivalent to the transpiled quantum circuit 122.

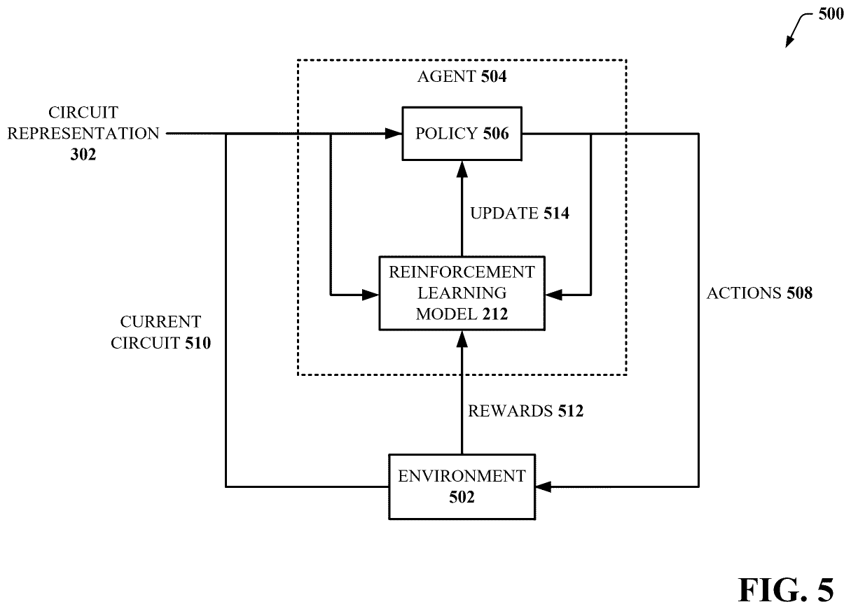

In order for the herein-described functionalities to be accurate, correct, or reliable, the reinforcement learning model 212, graph neural network 214, and classifier 216 described herein can first undergo training. In various embodiments, training component 206 can facilitate such training of the reinforcement learning model 212, graph neural network 214, and classifier 216. Non-limiting aspects of such training are described with respect to FIGS. 5-12.

In various embodiments, reinforcement learning model 212, graph neural network 214, and classifier 216 can be separate models. In other instances, reinforcement learning model 212, graph neural network 214, and classifier 216 can be sub-models of a singular model. In any case, reinforcement learning model 212, graph neural network 214, and classifier 216 can collectively form or comprise any suitable model architecture to facilitate artificially intelligent transpilation of quantum circuits as described herein.

In various instances, the execution component 210 can instruct, command, or otherwise cause the transpiled quantum circuit 124 to be executed on, implemented on, or otherwise performed on the quantum system 112. That is, the execution component 210 can initialize the states of the set of qubits 116 in any suitable fashion and can manipulate those initialized states according to whatever quantum operations are specified or otherwise called for by the quantum circuit 120. After such execution, the execution component 210 can instruct, command, or otherwise cause the quantum system 112 to perform a respective quantum read or measurement operation on each of the set of qubits 116.

Note that, in various instances, the input component 202, the learning component 204, the training component 206, verification component 208, and the execution component 210 can collectively be considered as being one or more software components of the circuit transpilation system 102. In various aspects, it should be appreciated that the one or more software components are described primarily herein as comprising four components (e.g., the input component 202, the learning component 204, the training component 206, verification component 208, and the execution component 210) for ease of explanation and illustration. However, the one or more software components are not limited to being implemented as exactly such five components in every embodiment. Indeed, in some embodiments, the functionalities described herein of such four components can be combined in any suitable fashions, so as to be implemented in or by fewer than five components (e.g., in some cases, a single component can perform all of the functionalities that are described herein with respect to the input component 202, the learning component 204, the training component 206, verification component 208, and the execution component 210). In other embodiments, the functionalities described herein of such five components can instead be distributed, separated, split, or fragmented in any suitable fashions, so as to be implemented in or by more than five components (e.g., two or more components can facilitate the functionalities that are performable by the input component 202; two or more components can facilitate the functionalities that are performable by the learning component 204; two or more components can facilitate the functionalities that are performable by the training component 206; two or more components can facilitate the functionalities that are performable by the verification component 208; two or more components can facilitate the functionalities that are performable by the execution component 210).

FIG. 3 illustrates another block diagram of an example, non-limiting system 300 that facilitates artificially intelligent transpilation of general quantum circuits in accordance with one or more embodiments described herein.

In various aspects, the graph neural network 214 can exhibit any suitable internal architecture. For example, graph neural network 214 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be graph convolutional layers, whose learnable or trainable parameters can be convolutional kernels. As even another example, any of such input layer, one or more hidden layers, or output layer can be dense layers, whose learnable or trainable parameters can be weight matrices or bias values. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of its specific internal architecture (e.g., of its specific numbers, types, or organizations of layers), the graph neural network 214 can be configured to generate a circuit representation 302 of quantum circuit 120 (e.g., or any input quantum circuit) such that circuits that are equivalent are mapped to similar or identical representations. Accordingly, the input component 204 can execute the graph neural network 214 on the quantum circuit 120, and such execution can cause the graph neural network 214 to produce the circuit representation 302 of quantum circuit 120. More specifically, the learning component 204 can feed the quantum circuit 120 to the input layer of the graph neural network 214. In various cases, the quantum circuit 120 can complete a forward pass through the one or more hidden layers of the reinforcement learning model 212. In various aspects, the output layer of the graph neural network 214 can compute or calculate the determine the circuit representation 302 based on activations provided by the one or more hidden layers of the graph neural network 214.

In various aspects, the reinforcement learning model 212 can exhibit any suitable internal architecture. In various instances, the reinforcement learning model 212 can be a deep learning neural network. For example, reinforcement learning model 212 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of its specific internal architecture (e.g., of its specific numbers, types, or organizations of layers), the reinforcement learning model 212 can be configured to transpile quantum circuit 120 to a sequence of gates (e.g., transpiled quantum circuit 122). Accordingly, the learning component 204 can execute the reinforcement learning model 212 on the circuit representation 302 of quantum circuit 120, and such execution can cause the reinforcement learning model 212 to produce transpiled quantum circuit 124. More specifically, the learning component 204 can feed the circuit representation 302 of quantum circuit 120 to the input layer of the reinforcement learning model 212. In various cases, the quantum circuit 120 can complete a forward pass through the one or more hidden layers of the reinforcement learning model 212. In various aspects, the output layer of the reinforcement learning model 212 can compute or calculate the transpiled quantum circuit 122 based on activations provided by the one or more hidden layers of the reinforcement learning model 212.

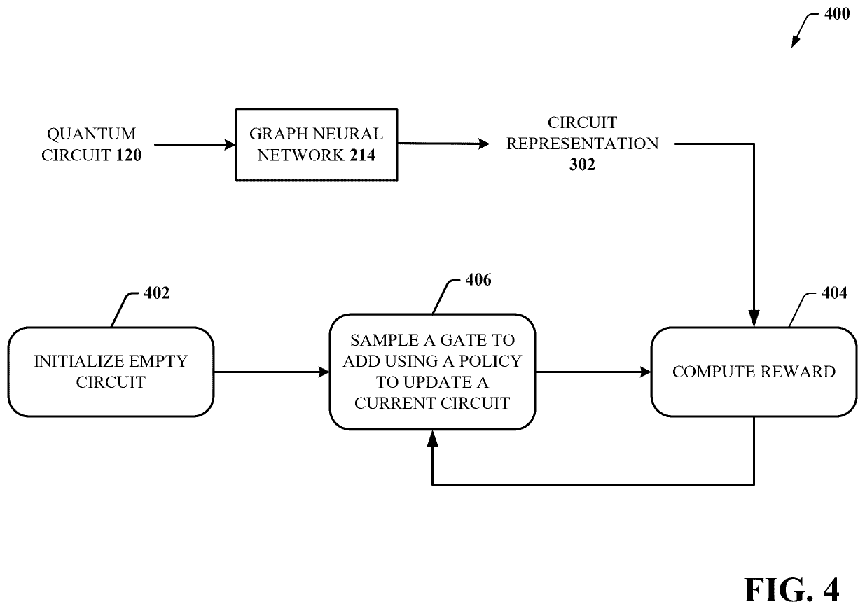

FIG. 4 illustrates an example, non-limiting diagram 400 showing how the reinforcement learning model 212 determines a next gate for generating transpiled quantum circuit 122 in accordance with one or more embodiments described herein.

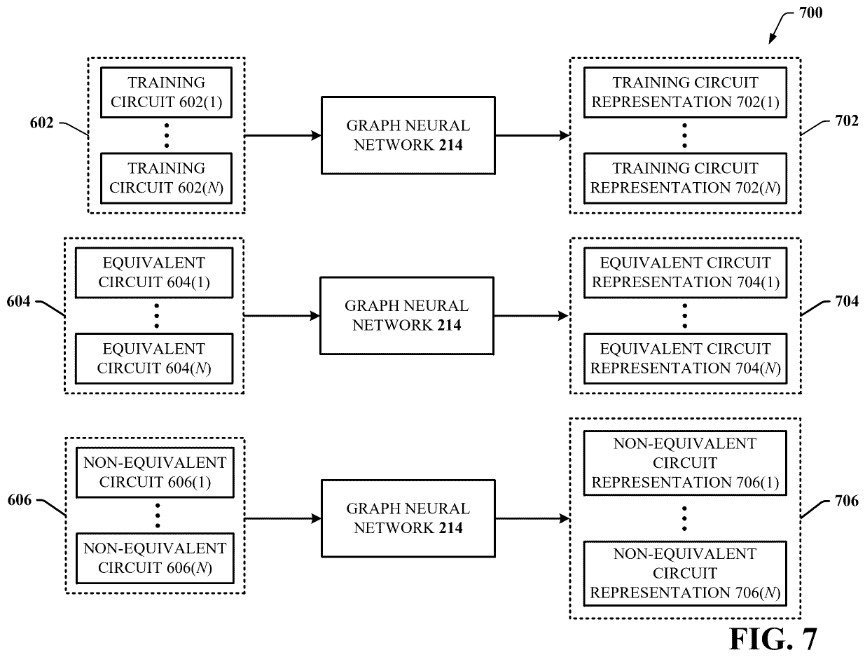

In various aspects, the learning component 204 can determine the transpiled quantum circuit 122 in an iterative synthesis process. More specifically, in response to receiving circuit representation 302 of quantum circuit 120 as input, at 402, learning component 204 can initialize a current circuit (e.g., current circuit 510) as an empty circuit. Thereafter, at 404, learning component 204 can sample a gate to add to the current circuit based on a policy, and update the current circuit by adding the gate. In other words, learning component 204 can initialize an empty circuit, wherein the reinforcement learning model 212 can iteratively determine a next gate to add to the empty circuit. In various aspects, following each iteration of updating the current circuit, learning component 204 can execute the graph neural network 214 on the current circuit to produce a circuit representation of the current circuit. Thus, at 406, learning component 204 can execute the reinforcement learning model 212 on circuit representation 302 and a circuit representation of the current circuit to determine a reward. M ore specifically, learning component 204 can check equivalence between circuit representation 302 and the circuit representation of the current circuit via the graph neural network 214. In various aspects, the graph neural network 214 can be trained to determine if a pair of circuits is equivalent, as described with respect to FIGS. 7-9.

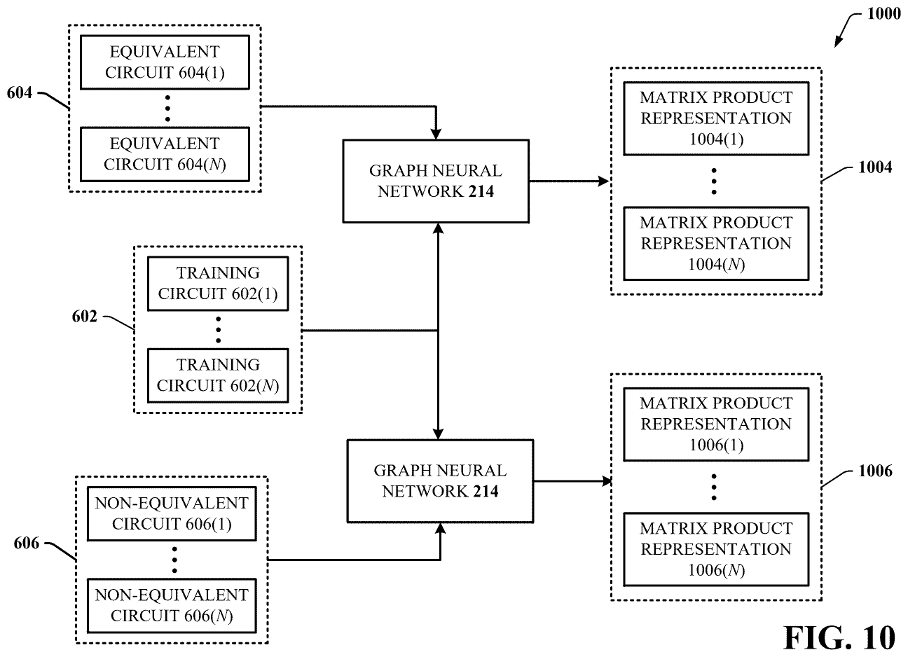

In other instances, learning component 204 can check equivalence between quantum circuit 120 and the current circuit via classifier 216. M ore specifically, verification component 208 can determine a matrix product between the current circuit and a transpose of the quantum circuit 120. Thereafter, verification component 208 can execute the graph neural network 214 on the matrix product to generate a circuit representation of the matrix product between the current circuit and a transpose of the quantum circuit 120. Thus, learning component 204 can execute classifier 216 on the circuit representation of the matrix product to determine if the circuit representation represents the identity circuit (e.g., is equivalent if the circuit representation represents the identity matrix, is not equivalent if the circuit representation does not represent the identity matrix). In various aspects, classifier 216 can be trained to determine if a pair of circuits is equivalent by training the classifier 216 to determine if a circuit representation of a matrix product between a first circuit and a transpose of a second circuit represents the identity circuit, as described with respect to FIGS. 10-12.

In any case, the learning component 204 can iteratively execute the reinforcement learning model 212 on the circuit representation 302 of quantum circuit 120 and the circuit representation of the current circuit to iteratively determine a reward based on equivalence between circuit representation 302 and the circuit representation of the current circuit. Accordingly, based on the reward, the reinforcement learning model 212 can update the policy to optimize decision-making for updating the current circuit to obtain transpiled quantum circuit 122.

FIG. 5 illustrates an example, non-limiting diagram 500 showing how the reinforcement learning model 212 facilitates circuit transpilation in accordance with one or more embodiments described herein.

In various aspects, prior to beginning training, training component 206 can initialize the trainable internal parameters (e.g., convolutional kernels, weight matrices, bias values) of the reinforcement learning model 212 in any suitable fashion (e.g., via random initialization).

In various embodiments, agent 504 can make decisions by selecting actions 508 to modify current circuit 510 (e.g., modifying gate sequences, reducing depth, sampling a gate) based on circuit representation 302 received as input. In various aspects, agent 504 can interact with an environment 502. In various embodiments, environment 502 can represent the quantum circuit optimization space, consisting of all possible transformations that can be applied to the current circuit 510. In some cases, the quantum circuit optimization space can consist of all possible transformations that can be applied with respect to constraints imposed by quantum hardware of quantum system 112. In various aspects, agent 504 can select actions 508 based on a policy 506. The policy 506 can define a decision-making strategy for selecting actions 508 during transpilation, guiding the reinforcement learning model 212 in making decisions that optimize the quantum circuit 120 (e.g., reduce gate depth or gate count). In various instances, the policy 506 can be updated by reinforcement learning model 212 through updates 514. M ore specifically, in response to applying actions 508 by agent 504, environment 502 can generate rewards 512. Accordingly, based on rewards 512, reinforcement learning model 212 can determine updates 514 to apply to policy 506. For instance, the actions 508 that agent 504 can take can include sampling a gate to add to the current circuit 510. That is, the agent 504 can sample a gate based on policy 506, and environment 502 can update the current circuit 510 by adding the gate to the current circuit 510. This process can be performed iteratively until the current circuit 510 is determined to be equivalent to the quantum circuit 120.

That is, after each iteration of sampling and adding a gate to current circuit 510, verification component 208 can determine if the current circuit 510 is equivalent to the quantum circuit 120. Particularly, the verification component 208 can engage the graph neural network 214 to generate a circuit representation of the current circuit 510. Thereafter, the verification component 208 can engage the graph neural network 214 to determine if the circuit representation of the current circuit 510 and the circuit representation 302 of quantum circuit 120 are equivalent.

Alternatively, the verification component 208 can engage the classifier 216 to determine if the circuit representation of the current circuit 510 and the circuit representation 302 of quantum circuit 120 are equivalent. As described herein, the classifier 216 can determine if two circuits are equivalent by determining if a circuit representation of a matrix product between the first circuit and a transpose of the second circuit represents the identity circuit.

The format, size, or dimensionality of the predicted sequence of gates (e.g., the transpiled quantum circuit 122) can be dictated by the structure of the reinforcement learning model 212, including the number of neurons, layers, or other internal parameters. In various aspects, the reinforcement learning model 212 can produce output that corresponds to a sequence of gates that the agent 504 believes will most efficiently implement the quantum circuit 120. To achieve this, policy 506 can improve over time as the agent 504 continues to interact with environment 502, learning to apply the most effective or efficient quantum gate based on rewards 512.

In various embodiments, there can be a set of training circuits (e.g., set of training circuits 602), as described with respect to FIGS. 5-12. For each training circuit, the above method can be applied to train the reinforcement learning model 212. Thus, policy 506 can be updated and improved over time based on rewards 512 generated by transpiling the set of training circuits.

For example, the reinforcement learning model 212 can be executed on each of the set of training circuits. During training, the environment 502 can generate rewards 512 based on a set of ground-truth circuits. More specifically, each ground-truth circuit can correspond to a training circuit, wherein ground-truth circuit is a sequence of gates that is known to be a correct or accurate transpiled circuit of the training circuit.

In various aspects, any suitable rewards 512 can be applied to update policy 506. For example, rewards 512 can be applied when the current circuit 510 is correct (e.g., the graph neural network 214 or classifier 216 deem that the current circuit 510 is equivalent to a ground-truth circuit of a training circuit, the graph neural network 214 or classifier 216 deem that the current circuit 510 is equivalent to the quantum circuit 120).

In various cases, such execution-and-update procedure can be repeated for any suitable number of training quantum circuits. This can ultimately cause the trainable internal parameters of the reinforcement learning model 212 to become iteratively optimized for accurately producing transpiled quantum circuit 124. In various aspects, any suitable training batch sizes, any suitable error/loss functions, or any suitable training termination criteria can be utilized during such training.

Although FIG. 5 shows the reinforcement learning model 212 as being trained in supervised fashion, this is a mere non-limiting example for ease of explanation and illustration. In various embodiments, any other suitable training paradigms can be used to train the reinforcement learning model 212, such as unsupervised training, any of which may be federated or non-federated.

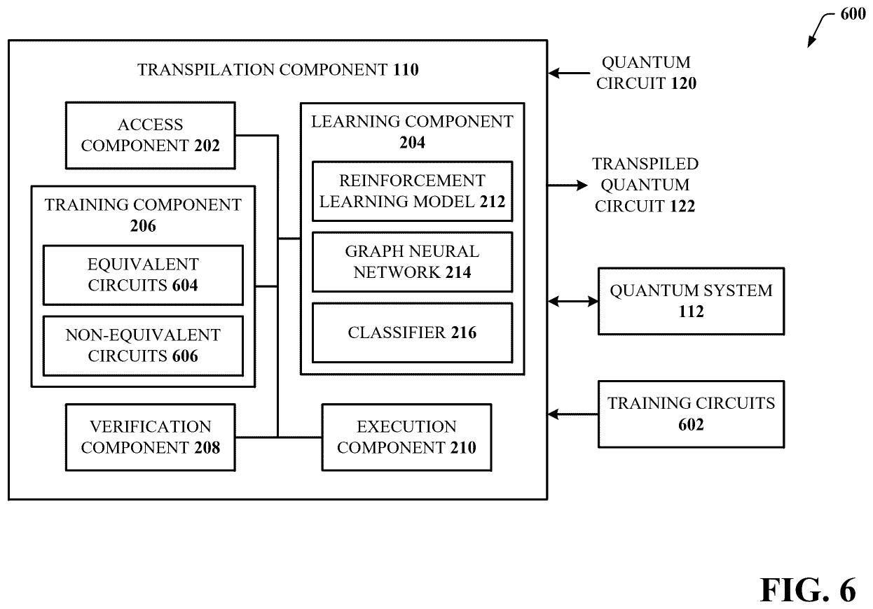

FIG. 6 illustrates another block diagram of an example, non-limiting system 600 that facilitates artificially intelligent transpilation of general quantum circuits in accordance with one or more embodiments described herein. As shown, the system 600 can, in some cases, comprise the same components as the system 200, and can further comprise a set of training circuits 602, a set of equivalent circuits 604, and a set of non-equivalent circuits 606.

In various aspects, the training component 206 can electronically receive, retrieve, obtain, or otherwise access, from any suitable source, the set of training circuits 602. In various aspects, the training component 206 can train the graph neural network 214 and the classifier 216 based on the set of training circuits 602.

In various embodiments, the training component 206 can generate the set of equivalent circuits 604 based on the set of training circuits 602 via any suitable transpilation method. That is, the set of equivalent circuits 604 can be considered as being circuits that are equivalent to the set of training circuits 602. More specifically, the training component 206 can generate, for each circuit in the set of training circuits 602, an equivalent circuit. In other words, each circuit in the set of equivalent circuits 604 can correspond to a circuit in the set of training circuits 602. That is, the training component 206 can generate, via the graph neural network 214, pairs of equivalent circuits (Cᵢ,Dᵢ)ᵢ₌₁ⁿ, where Cᵢ denotes a training circuit and Dᵢ denotes an equivalent circuit of the training circuit.

In some cases, the training component 206 can generate one or more circuits that are equivalent to each circuit in the set of training circuits 602. In such instances, the set of equivalent circuits 604 will be larger than the set of training circuits 602.

Similarly, the training component 206 can generate the set of non-equivalent circuits 606 based on the set of training circuits 602 via any suitable method, such as random sampling. That is, the set of non-equivalent circuits 606 can be considered as being circuits that are not equivalent to the set of training circuits 602. More specifically, the training component 206 can generate, for each circuit in the set of training circuits 602, a non-equivalent circuit. In other words, each circuit in the set of non-equivalent circuits 606 can correspond to a circuit in the set of training circuits 602. That is, the training component 206 can generate, via the graph neural network 214, pairs of non-equivalent circuits (Cᵢ,Eᵢ)ᵢ₌₁ⁿ, where Cᵢ denotes a training circuit and Eᵢ denotes a non-equivalent circuit of the training circuit.

In some cases, the training component 206 can generate one or more circuits that are not equivalent to each circuit in the set of training circuits 602. In such instances, the set of non-equivalent circuits 606 will be larger than the set of training circuits 602.

In any case, the training component 206 can train the graph neural network 214 and the classifier 216 based on the set of training circuits 602, the set of equivalent circuits 604, and the set of non-equivalent circuits 606. Various non-limiting aspects are described with respect to FIGS. 7-12. In particular, FIGS. 7-9 describes a first methodology for generating efficient circuit representations of quantum circuits such that equivalent circuits have equal representations, and FIGS. 10-12 describes a second methodology for generating efficient circuit representations of quantum circuits such that equivalent circuits have equal representations. More specifically, the first methodology involves using contrastive learning (i.e., a machine learning technique that learns representations by contrasting positive (similar) and negative (dissimilar) pairs of data, aiming to map similar instances closer and dissimilar instances further apart in an embedding space) to train the graph neural network 214 to generate such efficient circuit representations, and the second methodology involves training the classifier 216 in parallel with the graph neural network 214 to generate such efficient circuit representations.

FIG. 7 illustrates an example, non-limiting block diagram 700 showing generation of circuit representations via the graph neural network 214 in accordance with one or more embodiments described herein.

In various embodiments, the set of training circuits 602 can comprise n training circuits for any positive integer n: a training circuit 602(1) to a training circuit 602(n).

In various aspects, the training component 206 can execute the graph neural network 214 on the set of training circuits 602, thereby causing the graph neural network 214 to produce a set of training circuit representations 702. M ore specifically, the training component 206 can execute the graph neural network 214 on a training circuit in the set of training circuits 602, thereby causing the graph neural network 214 to produce a training circuit representation that corresponds to the training circuit. That is, the set of training circuit representations 702 can comprise n training circuit representations: a training circuit representation 702(1) to a training circuit representation 702(n), where each training circuit representation 702(i) for any positive integer i≤n corresponds to a training circuit 602(i).

In various aspects, the set of training circuit representations 702 can exhibit any suitable format, size, or dimensionality. For example, the set of training circuit representations 702 can comprise one or more scalars, one or more vectors, one or more matrices, one or more tensors, one or more character strings, or any suitable combination thereof.

Similarly, the training component 206 can execute the graph neural network 214 on the set of equivalent circuits 604, thereby causing the graph neural network 214 to produce a set equivalent circuit representations 704. More specifically, the training component 206 can execute the graph neural network 214 on an equivalent circuit in the set of equivalent circuits 604, thereby causing the graph neural network 214 to produce an equivalent circuit representation that corresponds to the equivalent circuit. That is, the set of equivalent circuit representations 704 can comprise n equivalent circuit representations: an equivalent circuit representation 704(1) to an equivalent circuit representation 704(n), where each equivalent circuit representation 704(i) for any positive integer i≤n corresponds to an non-equivalent circuit 606(i).

In various aspects, the set of equivalent circuit representations 704 can exhibit any suitable format, size, or dimensionality. For example, the set of equivalent circuit representations 704 can comprise one or more scalars, one or more vectors, one or more matrices, one or more tensors, one or more character strings, or any suitable combination thereof.

In various embodiments, the training component 206 can execute the graph neural network 214 on the set of non-equivalent circuits 606, thereby causing the graph neural network 214 to produce a set non-equivalent circuit representations 706. M ore specifically, the training component 206 can execute the graph neural network 214 on a non-equivalent circuit in the set of non-equivalent circuits 606, thereby causing the graph neural network 214 to produce a non-equivalent circuit representation that corresponds to the non-equivalent circuit. That is, the set of non-equivalent circuit representations 706 can comprise n non-equivalent circuit representations: a non-equivalent circuit representation 706(1) to a non-equivalent circuit representation 706(n), where each non-equivalent circuit representation 706(i) for any positive integer i≤n corresponds to a non-equivalent circuit 606(i).

In various aspects, the set of non-equivalent circuit representations 706 can exhibit any suitable format, size, or dimensionality. For example, the set of non-equivalent circuit representations 706 can comprise one or more scalars, one or more vectors, one or more matrices, one or more tensors, one or more character strings, or any suitable combination thereof.

Thus, the training component 206 can train the graph neural network 214 on pairs of circuit representations (vᵢ,vⱼ), where (vᵢ,vⱼ) denotes a pair of equivalent circuits or a pair of non-equivalent circuits. More specifically, vᵢ can denote a training circuit representation and vⱼ can denote an equivalent circuit representation or a non-equivalent circuit representation.

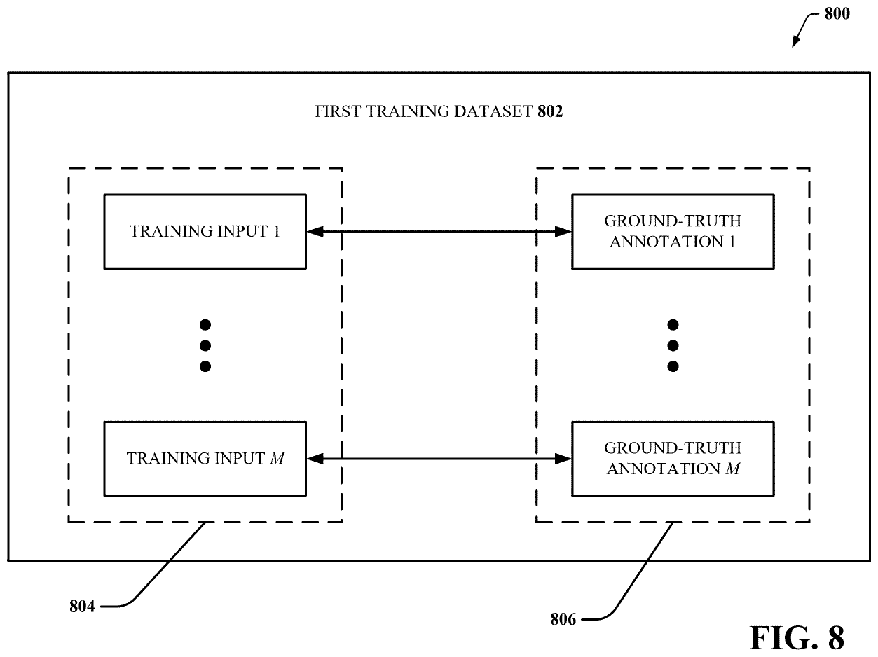

FIG. 8 illustrates an example, non-limiting block diagram 800 of a training dataset 802 in accordance with one or more embodiments described herein. As shown, the training dataset 802 can, in various aspects, comprise a set of training inputs 804 and a set of ground-truth annotations 806.

In various aspects, the set of training inputs 804 can include m inputs for any suitable positive integer m: a training input 1 to a training input m. In various instances, a training input can be any suitable electronic data representing a pair of equivalent circuit representations. In other words, the training input can comprise a training circuit representation 702(i) and an equivalent circuit representation 704(i) that it corresponds to. For example, the training input 1 can include a circuit representation of a first training circuit and a circuit representation of a transpiled circuit that the first training circuit is equivalent to. Likewise, as another example, the training input m can include a circuit representation of an m-th training circuit and a circuit representation of a transpiled circuit that the m-th training circuit is equivalent to.

In other instances, a training input can be any suitable electronic data representing a pair of non-equivalent circuit representations. In other words, the training input can comprise a training circuit representation 702(i) and a non-equivalent circuit representation 706(i) that it corresponds to. For example, the training input 1 can include a circuit representation of a first training circuit and a circuit representation of a randomly sampled circuit that the first training circuit is not equivalent to. Likewise, as another example, the training input m can include a circuit representation of an m-th training circuit and a circuit representation of a randomly sampled circuit that the m-th training circuit is not equivalent to.

Thus, the set of training inputs 804 can include pairs of equivalent circuit representations and/or pairs of non-equivalent circuit representations (vᵢ,vⱼ).

In various aspects, the set of ground-truth annotations 806 can respectively correspond (e.g., in one-to-one fashion) to the set of training inputs 804. Thus, since the set of training inputs 804 can have m inputs, the set of ground-truth annotations 806 can have m annotations: a ground-truth annotation 1 to a ground-truth annotation m. In various embodiments, the set of ground-truth annotations 806 can indicate if a pair of circuit representations is equivalent or not equivalent. For example, the ground-truth annotation 1 can correspond to the training input 1. Accordingly, the ground-truth annotation 1 can be considered as the correct or accurate classification label that indicates if the training circuit representation and the corresponding circuit representation in the training input 1 is equivalent or not equivalent (e.g., if the corresponding circuit representation is an equivalent circuit representation or if the corresponding circuit representation is a non-equivalent circuit representation). As another example, the ground-truth annotation m can correspond to the training input m. Accordingly, the ground-truth annotation m can be considered as the correct or accurate classification label that indicates if the training circuit representation and the corresponding circuit representation in the training input m is equivalent or not equivalent (e.g., if the corresponding circuit representation is an equivalent circuit representation or if the corresponding circuit representation is a non-equivalent circuit representation).

In various instances, each of the set of ground-truth annotations 806 can be any suitable electronic data exhibiting any suitable format, size, or dimensionality. That is, the set of ground-truth annotations 806 can be one or more scalars, one or more vectors, one or more matrices, one or more tensors, one or more character strings, or any suitable combination thereof.

As a non-limiting example, each of the set of ground-truth annotations 806 can be a binary or binomial variable; that is, a variable that can take on one of two possible discrete states. In such case, one of the two possible discrete states can represent an “equivalent” state, whereas the other of the two possible discrete states can represent a “non-equivalent” state. That is, a ground-truth annotation can take on the “equivalent” state when the graph neural network 214 infers that the pair of circuit representations (vᵢ,vⱼ) in the training input is equivalent, and the ground-truth annotation can take on the “non-equivalent” state when the graph neural network 214 infers that the pair of circuit representations (vᵢ,vⱼ) in the training input is not equivalent. As another non-limiting example, the ground-truth annotation can be a variable that can take on one of two possible discrete values (e.g., 0 or 1), where the ground-truth annotation can equal 1 when the graph neural network 214 infers that the pair of circuit representations (vᵢ,vⱼ) in the training input is equivalent, and the ground-truth annotation can equal 0 when the graph neural network 214 infers that the pair of circuit representations (vᵢ,vⱼ) in the training input is not equivalent.

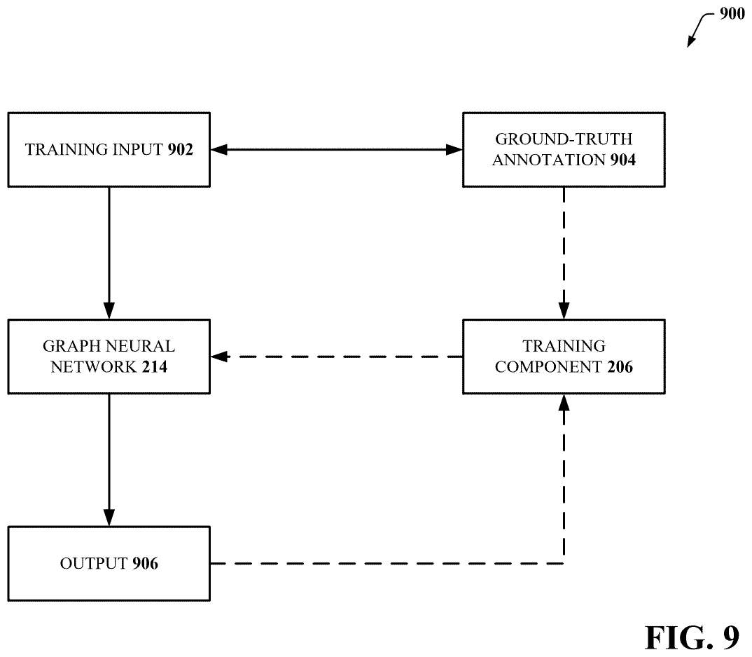

Now, consider FIG. 9. FIG. 9 illustrates an example, non-limiting block diagram 900 showing how the graph neural network 214 can be trained in accordance with one or more embodiments described herein.

In various aspects, the training component 206 can, prior to beginning training, initialize in any suitable fashion (e.g., random initialization) the trainable internal parameters (e.g., convolutional kernels, weight matrices, bias values) of the graph neural network 214.

In various aspects, the training component 206 can select, from the training dataset 802, a training input 902 and a ground-truth annotation 904 corresponding to the training input 902. In various instances, the training component 206 can execute the graph neural network 214 on the training input 902, thereby causing the graph neural network 214 to produce an output 906. M ore specifically, in some cases, an input layer of the graph neural network 214 can receive the training input 902, the training input 902 can complete a forward pass through one or more hidden layers of the graph neural network 214, and an output layer of the graph neural network 214 can compute the output 906 based on activation maps or intermediate features provided by the one or more hidden layers.

In various aspects, the output 906 can be considered as the predicted or inferred classification (e.g., the predicted or inferred equivalent classification or the predicted or inferred non-equivalent classification) that the graph neural network 214 believes should correspond to the training input 902. In contrast, the ground-truth annotation 904 can be considered as the correct/accurate classification (e.g., the correct equivalent classification or the correct non-equivalent classification) that is known or deemed to correspond to the training input 902. Note that, if the graph neural network 214 has so far undergone no or little training, then the output 906 can be highly inaccurate. In other words, the output 906 can be very different from the ground-truth annotation 904.

In various aspects, the training component 206 can compute one or more errors or losses (e.g., MAE, MSE, cross-entropy) between the output 906 and the ground-truth annotation 904. In various instances, the training component 206 can incrementally update, via backpropagation, the trainable internal parameters of the graph neural network 214, based on such one or more errors or losses.

In various cases, the training component 206 can repeat such execution-and-update procedure for each training input in the training dataset 802. This can ultimately cause the trainable internal parameters of the graph neural network 214 to become iteratively optimized for accurately generating circuit representations of quantum circuits such that equivalent quantum circuits have equal circuit representations. M ore specifically, this can ultimately cause the trainable internal parameters of the graph neural network 214 to minimize distance between circuit representations of equivalent circuits and to maximize distance between circuit representations of non-equivalent circuits.

In various aspects, the training component 206 can implement any suitable training batch sizes, any suitable error/loss functions, or any suitable training termination criteria.

Particularly, in various embodiments, the training component 206 can train the parameters of the graph neural network 214 to minimize distance between circuit representations of equivalent circuits. Further, the training component 206 can train the parameters of the graph neural network 214 to maximize distance between circuit representations of non-equivalent circuits. To facilitate this, the training component 206 can implement the following loss function:
[symbol] =Σ_{(i,j)ϵEquiv}∥vᵢ−vⱼ∥²−Σ_{(i,j)ϵInequiv}∥vᵢ−vⱼ∥² where Equiv denotes the set of equivalent circuit representation pairs (e.g., a training circuit representation 702(i) and an equivalent circuit representation 704(i)) and Inequiv denotes the set of non-equivalent circuit representation pairs (e.g., a training circuit representation 702(i) and a non-equivalent circuit representation 706(i)).

In various aspects, by minimizing the first term Σ_{(i,j)ϵEquiv}∥vᵢ−vⱼ∥² in the loss function £, the graph neural network 214 can be encouraged to generate circuit representations that are closer together (i.e., have shorter distances between them) for pairs of equivalent circuits. Likewise, by maximizing the second term −Σ_{(i,j)ϵInequiv}∥vᵢ−vⱼ∥² in the loss function £, the graph neural network 214 can be penalized when non-equivalent circuit representations are close together. Since the second term is subtracted, minimizing the loss function £ effectively increases distances between non-equivalent circuits.

FIG. 10 illustrates an example, non-limiting block diagram 1000 showing generation of circuit representations via a graph neural network in accordance with one or more embodiments described herein.

In various instances, the training component 206 can concatenate the set of training circuit representations 702 with the set of equivalent circuit representations 704. Likewise, the training component 206 can concatenate the set of training circuit representations 702 with the set of non-equivalent circuit representations 706.

In various aspects, the training component 206 can execute the graph neural network 214 on matrix products of the set of equivalent circuits 604 and transposes of the set of training circuits 602, thereby causing the graph neural network 214 to produce a set of matrix product representations 1004. M ore specifically, the training component 206 can execute the graph neural network 214 on a matrix product of an equivalent circuit of the set of equivalent circuits 604 and a transpose of a training circuit in the set of training circuits 602, thereby causing the graph neural network 214 to produce a matrix product representation that corresponds to the matrix product of the equivalent circuit and the transpose of the training circuit. That is, the set of matrix product representations 1004 can comprise n matrix product representations: a matrix product representation 1004(1) to a matrix product representation 1004(n), where each matrix product representation 1004(i) for any positive integer i≤n corresponds to a matrix product of the non-equivalent circuit 606(i) and a transpose of the training circuit 602(i).

In various aspects, the set of matrix product representations 1004 can exhibit any suitable format, size, or dimensionality. For example, the set of matrix product representations 1004 can comprise one or more scalars, one or more vectors, one or more matrices, one or more tensors, one or more character strings, or any suitable combination thereof.

Similarly, the training component 206 can execute the graph neural network 214 on matrix products of the set of non-equivalent circuits 606 and transposes of the set of training circuits 602, thereby causing the graph neural network 214 to produce a set of matrix product representations 1006. M ore specifically, the training component 206 can execute the graph neural network 214 on a matrix product of a non-equivalent circuit of the set of non-equivalent circuits 606 and a transpose of a training circuit in the set of training circuits 602, thereby causing the graph neural network 214 to produce a matrix product representation that corresponds to the matrix product of the non-equivalent circuit and the transpose of the training circuit. That is, the set of matrix product representations 1006 can comprise n matrix product representations: a matrix product representation 1006(1) to a matrix product representation 1006(n), where each matrix product representation 1006(i) for any positive integer i≤n corresponds to a matrix product of the non-equivalent circuit 606(i) and a transpose of the training circuit 602(i).

In various aspects, the set of matrix product representations 1006 can exhibit any suitable format, size, or dimensionality. For example, the set of matrix product representations 1006 can comprise one or more scalars, one or more vectors, one or more matrices, one or more tensors, one or more character strings, or any suitable combination thereof.

Thus, the training component 206 can train the classifier 216 to identify if matrix products

$${C}_{i}^{T}$$

Dᵢ is equivalent to an identity circuit I or if matrix product representations

$${C}_{i}^{T}$$

Eᵢ is equivalent to the identity circuit I.

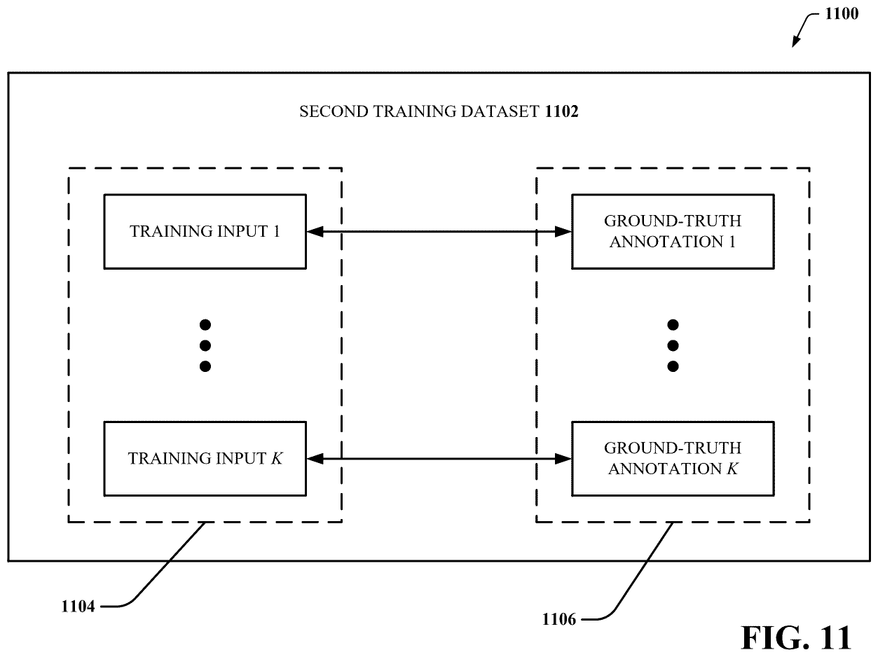

FIG. 11 illustrates an example, non-limiting block diagram 1100 of a training dataset 1102 in accordance with one or more embodiments described herein. As shown, the training dataset 1102 can, in various aspects, comprise a set of training inputs 1104 and a set of ground-truth annotations 1106.

In various aspects, the set of training inputs 1104 can include k inputs for any suitable positive integer k: a training input 1 to a training input k. In various instances, a training input can be any suitable electronic data having the same format, size, or dimensionality as the matrix product representations 1004. In other words, the training input can comprise a matrix product representation 1004(i) corresponding to a training circuit representation 702(i) and an equivalent circuit representation 704(i). For example, the training input 1 can include a circuit representation of a matrix product between a transpose of a first training circuit and an equivalent circuit. Likewise, as another example, the training input k can include a circuit representation of a matrix product between a transpose of a k-th training circuit and an equivalent circuit.

In other instances, a training input can be any suitable electronic data having the same format, size, or dimensionality as the matrix product representations 1006. In other words, the training input can comprise a matrix product representation 1006(i) corresponding to a training circuit representation 702(i) and a non-equivalent circuit representation 706(i). For example, the training input 1 can include a circuit representation of a matrix product between a transpose of a first training circuit and a non-equivalent circuit. Likewise, as another example, the training input k can include a circuit representation of a matrix product between a transpose of a k-th training circuit and a non-equivalent.

Thus, the set of training inputs 1104 can include circuit representations of matrix products between equivalent circuits Dᵢ and transposes of training circuits

$${C}_{i}^{T} ,$$

of between non-equivalent circuits Eᵢ and transposes of training circuits

$${C}_{i}^{T} .$$

In various aspects, the set of ground-truth annotations 1106 can respectively correspond (e.g., in one-to-one fashion) to the set of training inputs 1104. Thus, since the set of training inputs 1104 can have k inputs, the set of ground-truth annotations 1106 can have k annotations: a ground-truth annotation 1 to a ground-truth annotation k. In various embodiments, the set of ground-truth annotations 1106 can indicate if a matrix product representation is equivalent to an identity circuit I. For example, the ground-truth annotation 1 can correspond to the training input 1. Accordingly, the ground-truth annotation 1 can be considered as the correct or accurate classification label that indicates if the matrix product representation in the training input 1 that corresponds to a training circuit and an equivalent or non-equivalent circuit is equivalent to the identity circuit. As another example, the ground-truth annotation k can correspond to the training input k. Accordingly, the ground-truth annotation k can be considered as the correct or accurate classification label that indicates if the matrix product representation in the training input k that corresponds to a training circuit and an equivalent or non-equivalent circuit is equivalent to the identity circuit.

In various instances, each of the set of ground-truth annotations 1106 can be any suitable electronic data exhibiting any suitable format, size, or dimensionality. That is, the set of ground-truth annotations 1106 can be one or more scalars, one or more vectors, one or more matrices, one or more tensors, one or more character strings, or any suitable combination thereof.

As a non-limiting example, each of the set of ground-truth annotations 1106 can be a binary or binomial variable; that is, a variable that can take on one of two possible discrete states. In such case, one of the two possible discrete states can represent an “equivalent” state, whereas the other of the two possible discrete states can represent a “non-equivalent” state. That is, a ground-truth annotation can take on the “equivalent” state when classifier 216 infers that the matrix product representation in the training input represents the identity matrix, and the ground-truth annotation can take on the “non-equivalent” state when the classifier 216 infers that the matrix product representation in the training input is does not represent the identity matrix. As another non-limiting example, the ground-truth annotation can be a variable that can take on one of two possible discrete values (e.g., 0 or 1), where the ground-truth annotation can equal 1 when the classifier 216 infers that the matrix product representation in the training input represents the identity matrix, and the ground-truth annotation can equal 0 when the classifier 216 infers that the matrix product representation in the training input is does not represent the identity matrix.

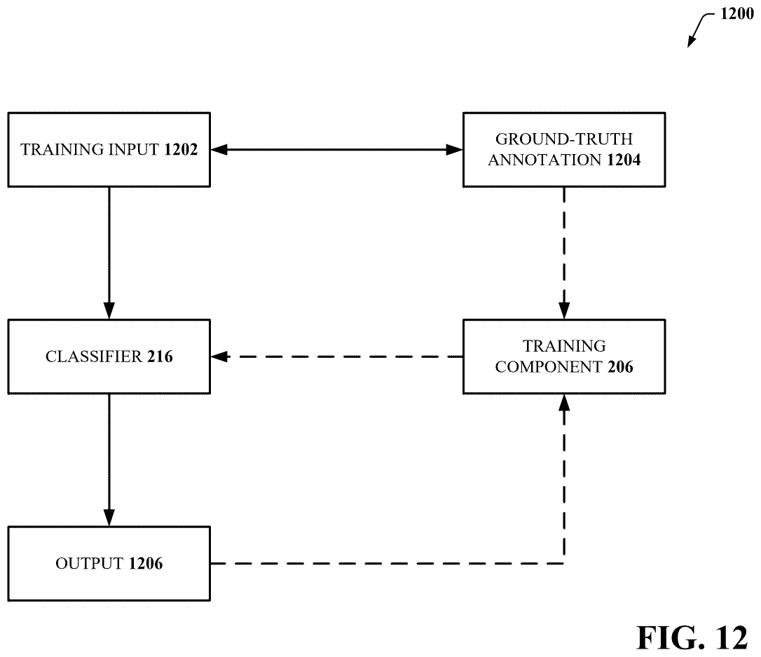

Now, consider FIG. 12. FIG. 12 illustrates an example, non-limiting block diagram 1200 showing how the classifier 216 can be trained in accordance with one or more embodiments described herein.

In various aspects, the training component 206 can, prior to beginning training, initialize in any suitable fashion (e.g., random initialization) the trainable internal parameters (e.g., convolutional kernels, weight matrices, bias values) of the classifier 216.

In various aspects, the training component 206 can select, from the training dataset 802, a training input 902 and a ground-truth annotation 904 corresponding to the training input 902. In various instances, the training component 206 can execute the classifier 216 on the training input 902, thereby causing the classifier 216 to produce an output 906. More specifically, in some cases, an input layer of the classifier 216 can receive the training input 902, the training input 902 can complete a forward pass through one or more hidden layers of the classifier 216, and an output layer of the classifier 216 can compute the output 906 based on activation maps or intermediate features provided by the one or more hidden layers.

In various aspects, the output 906 can be considered as the predicted or inferred classification (e.g., the predicted or inferred classification that the matrix product representation represents the identity matrix or the predicted or inferred classification that the matrix product representation does not represent the identity matrix) that the classifier 216 believes should correspond to the training input 902. In contrast, the ground-truth annotation 904 can be considered as the correct/accurate classification (e.g., the correct classification that the matrix product representation represents the identity matrix or the correct classification that the matrix product representation does not represent the identity matrix) that is known or deemed to correspond to the training input 902. Note that, if the classifier 216 has so far undergone no or little training, then the output 906 can be highly inaccurate. In other words, the output 906 can be very different from the ground-truth annotation 904.

In various aspects, the training component 206 can compute one or more errors or losses (e.g., MAE, MSE, cross-entropy) between the output 906 and the ground-truth annotation 904. In various instances, the training component 206 can incrementally update, via backpropagation, the trainable internal parameters of the classifier 216, based on such one or more errors or losses.

In various cases, the training component 206 can repeat such execution-and-update procedure for each training input in the training dataset 1102. This can ultimately cause the trainable internal parameters of the classifier 216 to become iteratively optimized for accurately determining if a matrix product representation represents the identity matrix. By training the classifier 216 to determine if the matrix product representation of a circuit and a transpose of a training circuit represents the identity circuit, the classifier 216 can effectively determine if the circuit and the training circuit are equivalent or not equivalent. More specifically, if the matrix product representation of a circuit and a transpose of another circuit represent the identity matrix, it indicates that the two circuits are equivalent. That is, it indicates that one circuit effectively reverses the transformations of the other circuit. In various aspects, the training component 206 can implement any suitable training batch sizes, any suitable error/loss functions, or any suitable training termination criteria.

By training classifier 216, computation time can be reduced during training as only a single graph neural network is used. Conversely, without classifier 216, graph neural network 214 is executed twice (e.g., once to generate circuit representations, and once to determine equivalence), increasing computation time. Thus, classifier 216 can reduce runtime and computation costs. Furthermore, by utilizing classifier 216 to determine equivalence as opposed to graph neural network 214, fewer training circuits are needed as the search space for graph neural network 214 is reduced.

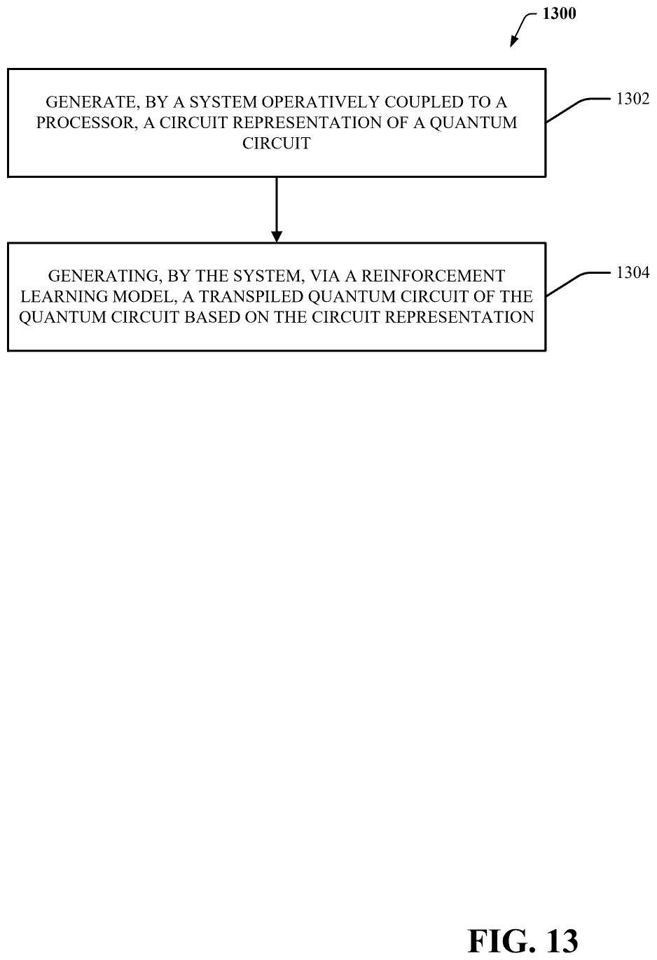

FIG. 13 illustrates a flow diagram of an example, non-limiting computer-implemented method 1300 that facilitates artificially intelligent transpilation of general quantum circuits in accordance with one or more embodiments described herein. In various cases, the circuit transpilation system 102 can facilitate the computer-implemented method 1300.

In various embodiments, act 1302 can include generating, by a system (e.g., via 202) operatively coupled to a processor (e.g., 104), a circuit representation (e.g., 302) of a quantum circuit (e.g., 120).

In various aspects, act 1304 can include generating, by the system (e.g., via 204), via a reinforcement learning model (e.g., via 212), a transpiled quantum circuit (e.g., via 122) of the quantum circuit based on the circuit representation.

Although not explicitly shown in FIG. 13, the computer-implemented method 1300 can further include outputting, by the device (e.g., via 204), the transpiled circuit.

Although not explicitly shown in FIG. 13, the computer-implemented method 1300 can further include executing, by the device (e.g., via 208), the transpiled circuit on the quantum system.

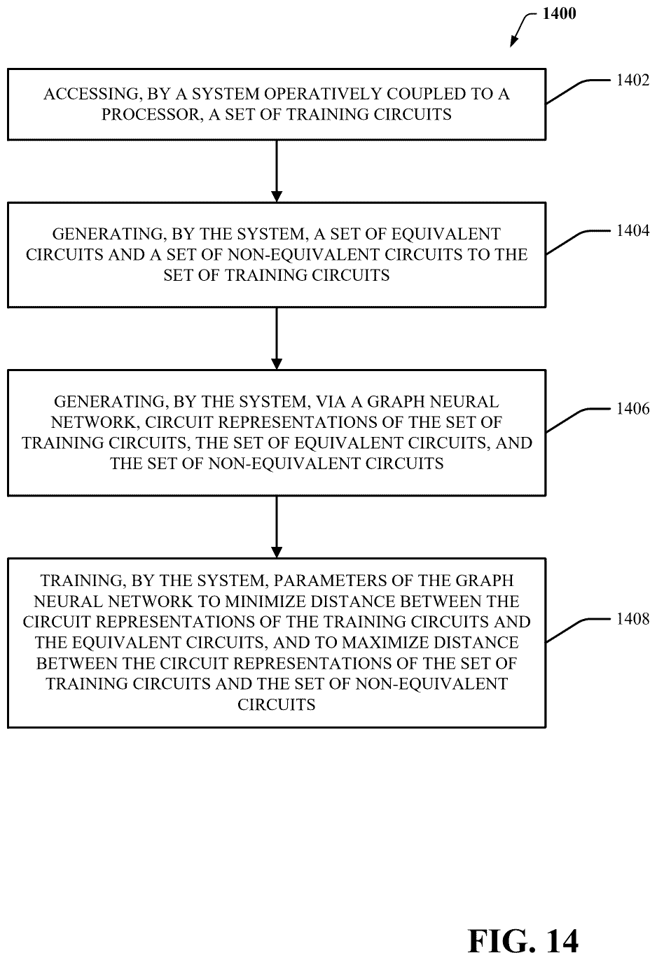

FIG. 14 illustrates a flow diagram of an example, non-limiting computer-implemented method 1400 that can facilitate artificially intelligent transpilation of general quantum circuits in accordance with one or more embodiments described herein. In various cases, the circuit transpilation system 102 can facilitate the computer-implemented method 1400.

In various aspects, act 1402 can include accessing, by the device (e.g., via 206), a reinforcement learning model (e.g., 210), a set of training circuits (e.g., 602).

In various aspects, act 1404 can include generating, by the device (e.g., via 206), a set of equivalent circuits (e.g., 604) and a set of non-equivalent circuits (e.g., 606) to the set of training circuits.

In various aspects, act 1406 can include generating, by the device (e.g., via 206), via a graph neural network (e.g., 214), circuit representations of the set of training circuits (e.g., 702), the set of equivalent circuits (e.g., 704), and the set of non-equivalent circuits (e.g., 706).

In various aspects, act 1408 can include training, by the device (e.g., via 206), parameters of the graph neural network to minimize distance between the circuit representations of the training circuits and the equivalent circuits, and to maximize distance between the circuit representations of the set of training circuits and the set of non-equivalent circuits.

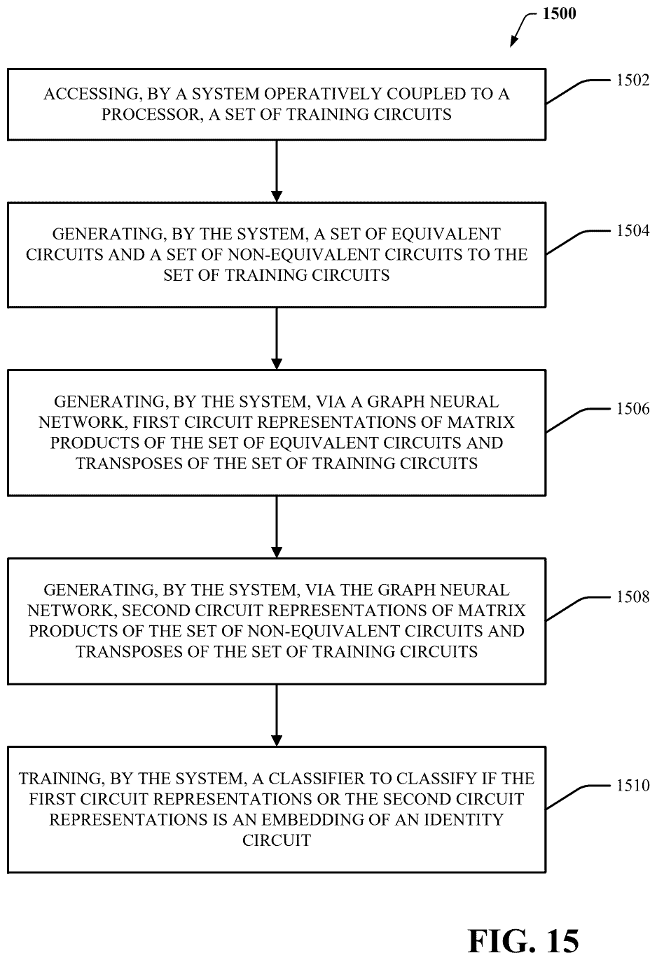

FIG. 15 illustrates a flow diagram of an example, non-limiting computer-implemented method 1500 that can facilitate artificially intelligent transpilation of general quantum circuits in accordance with one or more embodiments described herein. In various cases, the circuit transpilation system 102 can facilitate the computer-implemented method 1500.

In various aspects, act 1502 can include accessing, by the device (e.g., via 206), a reinforcement learning model (e.g., 210), a set of training circuits (e.g., 602).

In various aspects, act 1504 can include generating, by the device (e.g., via 206), a set of equivalent circuits (e.g., 604) and a set of non-equivalent circuits (e.g., 606) to the set of training circuits.

In various aspects, act 1506 can include generating, by the device (e.g., via 206), via a graph neural network (e.g., 214), first circuit representations of matrix products of the set of equivalent circuits and transposes of the set of training circuits (e.g., 1004).

In various aspects, act 1508 can include generating, by the device (e.g., via 206), via the graph neural network, second circuit representations of matrix products of the set of non-equivalent circuits and transposes of the set of training circuits (e.g., 1004).

In various aspects, act 1510 can include training, by the device (e.g., via 206), a classifier (e.g., 216) to classify if the first circuit representations or the second circuit representations is an embedding of an identity circuit. In other words, the classifier 216 can be trained to determine if the first circuit representations or the second circuit representations represent or are equivalent to the identity circuit.

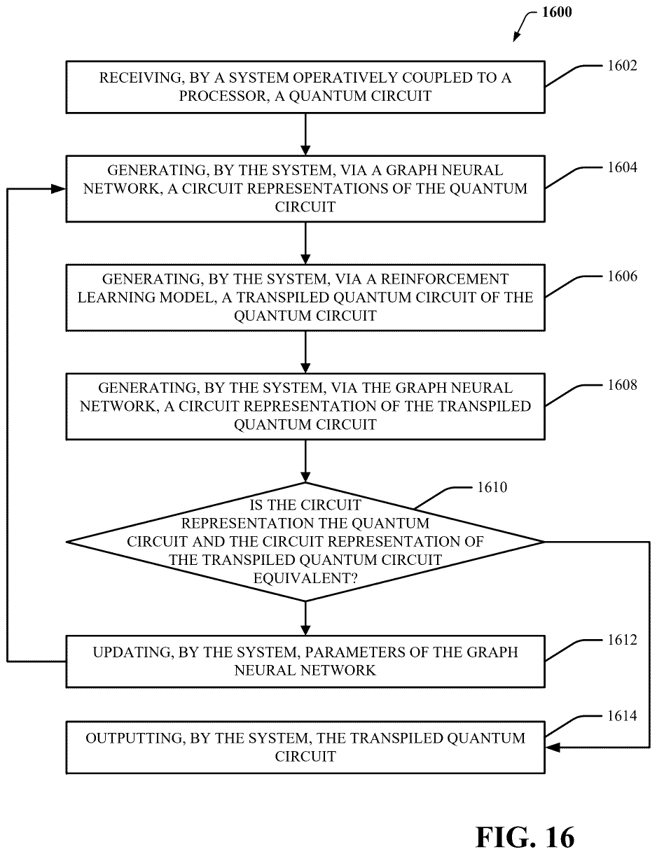

FIG. 16 illustrates a flow diagram of an example, non-limiting computer-implemented method 1600 that can facilitate artificially intelligent transpilation of general quantum circuits in accordance with one or more embodiments described herein. In various cases, the circuit transpilation system 102 can facilitate the computer-implemented method 1600.

In various aspects, act 1602 can include receiving, by the device (e.g., via 202), a quantum circuit (e.g., 120).

In various aspects, act 1604 can include generating, by the device (e.g., via 204), via a graph neural network (e.g., 214), a circuit representation of the quantum circuit.

In various aspects, act 1606 can include generating, by the device (e.g., via 204), via a reinforcement learning model (e.g., 212), a transpiled quantum circuit (e.g., 122) of the quantum circuit.

In various aspects, act 1608 can include generating, by the device (e.g., via 206), via the graph neural network, a circuit representation of the transpiled quantum circuit (e.g., 1004). In various aspects, the current circuit as described herein can be considered the transpiled circuit at each iteration of sampling a gate to add.

In various aspects, act 1610 can include determining, by the system (e.g., via 206), whether the circuit representation of the quantum circuit and the circuit representation of the transpiled quantum circuit are equivalent. If so, the computer-implemented method 1600 can proceed to act 1614. If not, the computer-implemented method 1600 can proceed back to act 1612.

In various aspects, act 1612 can include updating, by the device (e.g., via 206), parameters of the graph neural network.

Although not explicitly shown in FIG. 16, the computer-implemented method 1600 can further include generating, by the device (e.g., via 204), a reward based on the equivalence between the transpiled circuit and the quantum circuit. Accordingly, the learning component 204 can update the parameters based on the rewards.

In various aspects, act 1614 can include outputting, by the device (e.g., via 204), the transpiled quantum circuit.

FIG. 17 and the following discussion are intended to provide a brief, general description of a suitable computing environment 1700 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1700 contains an example of an environment for the execution of at least some of the computer code involved in performing the inventive methods, such as artificially intelligent transpilation of quantum circuits code 1728. In addition to block 1728, computing environment 1700 includes, for example, computer 1701, wide area network (WAN) 1702, end user device (EUD) 1703, remote server 1704, public cloud 1705, and private cloud 1706. In this embodiment, computer 1701 includes processor set 1710 (including processing circuitry 1720 and cache 1721), communication fabric 1711, volatile memory 1712, persistent storage 1713 (including operating system 1722 and block 1728, as identified above), peripheral device set 1714 (including user interface (UI), device set 1723, storage 1724, and Internet of Things (IoT) sensor set 1725), and network module 1715. Remote server 1704 includes remote database 1730. Public cloud 1705 includes gateway 1740, cloud orchestration module 1741, host physical machine set 1742, virtual machine set 1743, and container set 1744.

COMPUTER 1701 can take the form of a desktop computer, laptop computer, tablet computer, smart phone, smart watch or other wearable computer, mainframe computer, quantum system or any other form of computer or mobile device now known or to be developed in the future that is capable of running a program, accessing a network or querying a database, such as remote database 1730. As is well understood in the art of computer technology, and depending upon the technology, performance of a computer-implemented method can be distributed among multiple computers or between multiple locations. On the other hand, in this presentation of computing environment 1700, detailed discussion is focused on a single computer, specifically computer 1701, to keep the presentation as simple as possible. Computer 1701 can be located in a cloud, even though it is not shown in a cloud in FIG. 17. On the other hand, computer 1701 is not required to be in a cloud except to any extent as can be affirmatively indicated.

PROCESSOR SET 1710 includes one, or more, computer processors of any type now known or to be developed in the future. Processing circuitry 1720 can be distributed over multiple packages, for example, multiple, coordinated integrated circuit chips. Processing circuitry 1720 can implement multiple processor threads or multiple processor cores. Cache 1721 is memory that is located in the processor chip package(s) and is typically used for data or code that should be available for rapid access by the threads or cores running on processor set 1710. Cache memories are typically organized into multiple levels depending upon relative proximity to the processing circuitry. Alternatively, some, or all, of the cache for the processor set can be located “off chip.” In some computing environments, processor set 1710 can be designed for working with qubits and performing quantum computing.

Computer readable program instructions are typically loaded onto computer 1701 to cause a series of operational steps to be performed by processor set 1710 of computer 1701 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1721 and the other storage media discussed below. The program instructions, and associated data, are accessed by processor set 1710 to control and direct performance of the inventive methods. In computing environment 1700, at least some of the instructions for performing the inventive methods can be stored in block 1728 in persistent storage 1713.

COMMUNICATION FABRIC 1711 is the signal conduction path that allows the various components of computer 1701 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1712 is any type of volatile memory now known or to be developed in the future. Examples include dynamic type random access memory (RAM) or static type RAM. Typically, the volatile memory is characterized by random access, but this is not required unless affirmatively indicated. In computer 1701, the volatile memory 1712 is located in a single package and is internal to computer 1701, but, alternatively or additionally, the volatile memory can be distributed over multiple packages or located externally with respect to computer 1701.

PERSISTENT STORAGE 1713 is any form of non-volatile storage for computers that is now known or to be developed in the future. The non-volatility of this storage means that the stored data is maintained regardless of whether power is being supplied to computer 1701 or directly to persistent storage 1713. Persistent storage 1713 can be a read only memory (ROM), but typically at least a portion of the persistent storage allows writing of data, deletion of data and re-writing of data. Some familiar forms of persistent storage include magnetic disks and solid-state storage devices. Operating system 1722 can take several forms, such as various known proprietary operating systems or open-source Portable Operating System Interface type operating systems that employ a kernel. The code included in block 1728 typically includes at least some of the computer code involved in performing the inventive methods.

PERIPHERAL DEVICE SET 1714 includes the set of peripheral devices of computer 1701. Data communication connections between the peripheral devices and the other components of computer 1701 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1723 can include components such as a display screen, speaker, microphone, wearable devices (such as goggles and smart watches), keyboard, mouse, printer, touchpad, game controllers, and haptic devices. Storage 1724 is external storage, such as an external hard drive, or insertable storage, such as an SD card. Storage 1724 can be persistent or volatile. In some embodiments, storage 1724 can take the form of a quantum computing storage device for storing data in the form of qubits. In embodiments where computer 1701 is required to have a large amount of storage (for example, where computer 1701 locally stores and manages a large database) then this storage can be provided by peripheral storage devices designed for storing large amounts of data, such as a storage area network (SAN) that is shared by multiple, geographically distributed computers. IoT sensor set 1725 is made up of sensors that can be used in Internet of Things applications. For example, one sensor can be a thermometer and another sensor can be a motion detector.

NETWORK MODULE 1715 is the collection of computer software, hardware, and firmware that allows computer 1701 to communicate with other computers through WAN 1702. Network module 1715 can include hardware, such as modems or Wi-Fi signal transceivers, software for packetizing or de-packetizing data for communication network transmission, or web browser software for communicating data over the internet. In some embodiments, network control functions and network forwarding functions of network module 1715 are performed on the same physical hardware device. In other embodiments (for example, embodiments that utilize software-defined networking (SDN)), the control functions and the forwarding functions of network module 1715 are performed on physically separate devices, such that the control functions manage several different network hardware devices. Computer readable program instructions for performing the inventive methods can typically be downloaded to computer 1701 from an external computer or external storage device through a network adapter card or network interface included in network module 1715.

WAN 1702 is any wide area network (for example, the internet) capable of communicating computer data over non-local distances by any technology for communicating computer data, now known or to be developed in the future. In some embodiments, the WAN can be replaced or supplemented by local area networks (LA Ns) designed to communicate data between devices located in a local area, such as a Wi-Fi network. The WAN or LA Ns typically include computer hardware such as copper transmission cables, optical transmission fibers, wireless transmission, routers, firewalls, switches, gateway computers and edge servers.

END USER DEVICE (EUD) 1703 is any computer system that is used and controlled by an end user (for example, a customer of an enterprise that operates computer 1701) and can take any of the forms discussed above in connection with computer 1701. EUD 1703 typically receives helpful and useful data from the operations of computer 1701. For example, in a hypothetical case where computer 1701 is designed to provide a recommendation to an end user, this recommendation would typically be communicated from network module 1715 of computer 1701 through WAN 1702 to EUD 1703. In this way, EUD 1703 can display, or otherwise present, the recommendation to an end user. In some embodiments, EUD 1703 can be a client device, such as thin client, heavy client, mainframe computer or desktop computer.

REMOTE SERVER 1704 is any computer system that serves at least some data or functionality to computer 1701. Remote server 1704 can be controlled and used by the same entity that operates computer 1701. Remote server 1704 represents the machine(s) that collect and store helpful and useful data for use by other computers, such as computer 1701. For example, in a hypothetical case where computer 1701 is designed and programmed to provide a recommendation based on historical data, then this historical data can be provided to computer 1701 from remote database 1730 of remote server 1704.

PUBLIC CLOUD 1705 is any computer system available for use by multiple entities that provides on-demand availability of computer system resources or other computer capabilities, especially data storage (cloud storage) and computing power, without direct active management by the scale. The direct and active management of the computing resources of public cloud 1705 is performed by the computer hardware or software of cloud orchestration module 1741. The computing resources provided by public cloud 1705 are typically implemented by virtual computing environments that run on various computers making up the computers of host physical machine set 1742, which is the universe of physical computers in or available to public cloud 1705. The virtual computing environments (VCEs) typically take the form of virtual machines from virtual machine set 1743 or containers from container set 1744. It is understood that these VCEs can be stored as images and can be transferred among and between the various physical machine hosts, either as images or after instantiation of the VCE. Cloud orchestration module 1741 manages the transfer and storage of images, deploys new instantiations of VCEs and manages active instantiations of VCE deployments. Gateway 1740 is the collection of computer software, hardware and firmware allowing public cloud 1705 to communicate through WAN 1702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1706 is similar to public cloud 1705, except that the computing resources are only available for use by a single enterprise. While private cloud 1706 is depicted as being in communication with WAN 1702, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1705 and private cloud 1706 are both part of a larger hybrid cloud.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude non-equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an input component that generates a circuit representation of a quantum circuit; and
a learning component that generates, via a reinforcement learning model, a transpiled circuit of the quantum circuit based on the circuit representation.

2. The system of claim 1, wherein the computer executable components further comprise:
a training component that trains a graph neural network (GNN) to generate circuit representations.

3. The system of claim 2, wherein training the GNN comprises:
generating respective equivalent circuits of a set of training circuits via transpilation; and
generating respective non-equivalent circuits of the set of training circuits via random sampling.

4. The system of claim 3, wherein training the GNN further comprises:
generating, via the GNN, circuit representations of the respective equivalent circuits, respective non-equivalent circuits, and the set of training circuits; and
training parameters of the GNN to minimize distance between the circuit representations of the respective equivalent circuits and maximize distance between the circuit representations of the respective non-equivalent circuits.

5. The system of claim 3, wherein training the GNN comprises:
generating, via the GNN, first circuit representations of matrix products of the respective equivalent circuits and transposes of the set of training circuits; and
generating, via the GNN, second circuit representations of matrix products of the respective non-equivalent circuits and transposes of the set of training circuits.

6. The system of claim 5, wherein training the GNN further comprises:
training a classifier to classify if the first circuit representations or the second circuit representations is an embedding of an identity circuit.

7. The system of claim 6, wherein the training component trains the classifier simultaneously with the GNN.

8. The system of claim 2, wherein the computer executable components further comprise:
a verification component that determines if a pair of circuits is equivalent based on the circuit representations generated by the GNN.

9. The system of claim 8, wherein the verification component determines if a pair of circuits is equivalent via the classifier.

10. The system of claim 1, wherein generating the transpiled circuit comprises:
iteratively sampling a gate to add to a current circuit based on a policy.

11. The system of claim 10, wherein the learning component iteratively generates a reward based on the circuit representation of the quantum circuit and a circuit representation of the current circuit.

12. A computer-implemented method, comprising:
generating, by a system operatively coupled to a processor, a circuit representation of a quantum circuit; and
generating, by the system, via a reinforcement learning model, a transpiled circuit of the quantum circuit based on the circuit representation.

13. The computer-implemented method of claim 12, further comprising:
training, by the system, a graph neural network (GNN) to generate circuit representations.

14. The computer-implemented method of claim 13, wherein training the GNN comprises:
generating, via the GNN, circuit representations of respective equivalent circuits of a set of training circuits and respective non-equivalent circuits of the set of training circuits; and
training parameters of the GNN to minimize distance between the circuit representations of the respective equivalent circuits and maximize distance between the circuit representations of the respective non-equivalent circuits.

15. The computer-implemented method of claim 14, wherein training the GNN comprises:
generating, via the GNN, first circuit representations of matrix products of the respective equivalent circuits and transposes of the set of training circuits; and
generating, via the GNN, second circuit representations of matrix products of the respective non-equivalent circuits and transposes of the set of training circuits.

16. The computer-implemented method of claim 13, further comprising:
determining, by the system, if a pair of circuits is equivalent based on the circuit representations generated by the GNN.

17. The computer-implemented method of claim 12, wherein generating the transpiled circuit comprises:
iteratively sampling a gate to add to a current circuit based on a policy.

18. The computer-implemented method of claim 17, further comprising:
iteratively generating, by the system, a reward based on the circuit representation of the quantum circuit and a circuit representation of the current circuit.

19. A computer program product for artificial intelligence-based transpilation of quantum circuits, the computer program product comprising a computer readable storage medium having program instructions embodied therewith, the program instructions executable by a processor to cause the processor to:
generate, by the processor, a circuit representation of a quantum circuit; and
generate, by the processor, via a reinforcement learning model, a transpiled circuit of the quantum circuit based on the circuit representation.

20. The computer program product of claim 19, wherein the program instructions are further executable by the processor to cause the processor to:
train, by the processor, a graph neural network (GNN) to generate circuit representations.
